(19) United States
(12) Patent Application Publication
(10) Pub. No.: US 2020/0193368 A1
(43) Pub. Date: Jun. 18, 2020

(54) TRANSPORTING OBJECTS USING AUTONOMOUS VEHICLES

(71) Applicant: Aptiv Technologies Limited, St. Michael (BB)

(72) Inventors: Gaurav Bhatia, Pittsburgh, PA (US); Thad Bobula, Pittsburgh, PA (US); Michael O'Har, Pittsburgh, PA (US); Matthew Andromalos, Pittsburgh, PA (US); Christopher P. Bird, Carnegie, PA (US)

(21) Appl. No.: 16/712,918

(22) Filed: Dec. 12, 2019

Related U.S. Application Data
(60) Provisional application No. 62/778,843, filed on Dec. 12, 2018.

(51) Int. Cl. G06Q 10/08; G06Q 50/30; H04W 4/021; H04W 4/40; B60R 25/10; G06Q 10/02; B60R 25/25

(52) U.S. Cl. CPC G06Q 10/0832; G06Q 50/30; G06Q 10/0835; H04W 4/021; B60R 2325/205; B60R 25/10; G06Q 10/02; B60R 25/25; B60R 2025/1016; H04W 4/40

(57) ABSTRACT

Techniques are disclosed for transporting objects using autonomous vehicles. In an embodiment, a customer makes a reservation with a transportation service provider (e.g., via an online booking application). The customer provides a pick-up date/pick-up time window, a destination and a description of the object(s) (e.g., luggage/cargo) that the customer will be transporting with or without themselves in the autonomous vehicle. After the computer system identifies the physical characteristics of the object(s), it identifies an autonomous vehicle with the appropriate amount of storage/container space with respect to the identified physical characteristics, and then assigns the vehicle to the customer. On or around the pick-up day, the computer system configures the assigned autonomous vehicle with reservation details including a description of the objects. At the pick-up location, sensors are used to authenticate/identify/localize/track each passenger and their respective objects, and to determine if any object is unsafe or illegal to transport.

### CROSS-REFERENCE TO RELATED APPLICATION

This application claims priority to U.S. Provisional Patent Application No. 62/778,843, filed Dec. 12, 2018, the entire contents of which is incorporated herein by reference.

### FIELD OF THE INVENTION

This description relates to transporting objects using autonomous vehicles.

### BACKGROUND

Autonomous vehicles can be used to transport passengers and objects (e.g., luggage, packages or other items) from one location to another location. For example, an autonomous vehicle can navigate to the location of a customer, wait for the customer to load their luggage and board the autonomous vehicle, and navigate to a specified destination (e.g., a location selected by the customer).

Objects transported by autonomous vehicles may vary in shape, size, weight, fragility and other characteristics. For example, autonomous vehicles may be used to transport bags, suitcases, groceries, furniture, plants, animals, etc. When procuring transportation services, the customer may not know how much storage space they need for transporting an object. Given the hundreds of different vehicles potentially available to a transportation service provider (e.g., taxi service, rental agency), and that each vehicle has a different square footage of storage space, the customer would have to read hundreds of vehicle descriptions to find an optimum autonomous vehicle to transport their object(s). Since transportation service provider fees tend to increase with the size of the vehicle, a customer may be overpaying for storage space they do not use. Likewise, if there is insufficient storage space in the vehicle for the object(s), the customer may have to upgrade to a larger vehicle on the pick-up day and thus may have to settle for whatever vehicle is available from the transportation service.

With autonomous vehicles (e.g., autonomous taxi or rentals) there is typically no driver present at the passenger pick-up and drop-off locations that can supervise the loading and unloading of objects to and from the vehicle. If multiple passengers share a ride, there is a possibility that a passenger mistakenly or intentionally takes another passenger's luggage/cargo at a drop-off location. It is also possible that unsafe or illegal objects are transported by the autonomous vehicle without the knowledge or consent of the transportation service provider.

### SUMMARY

Techniques are disclosed for transporting objects using autonomous vehicles. In an embodiment, a customer makes a reservation with a transportation service provider (e.g., taxi/rental service) using a computer system (e.g., via an online booking application). The customer provides a pick-up date/time, a destination and a description of the object(s) (e.g., luggage/cargo) that the customer will be transporting with in the autonomous vehicle. Once the computer system identifies the physical characteristics of the object(s), the computer system identifies an autonomous vehicle with the appropriate amount of storage space with respect to the identified physical characteristics, and reserves the vehicle for the customer. On or around the day of pick-up, the computer system configures the assigned autonomous vehicle's computer system with the reservation details. At the pick-up location, sensors are used to authenticate/identify each passenger and their object(s) and also determine if any object is unsafe or illegal to transport.

Upon confirming a reservation, in an embodiment the transportation service provider sends one or more radio frequency identification (RFID) tags to the customer's home or office address using a mail or package delivery service. The RFID tags can be attached by the customer to the objects to be transported. Each tag contains a unique identifier that can be mapped to a database operated by the transportation service provider. The database contains a record with a description of the object (e.g., a suitcase, duffle bag, skis), the identity and credentials of a passenger that owns the object and any other desired information that can associate the passenger with the reservation details and the object. An RFID reader located in the storage space/container of the autonomous vehicle receives a unique identifier from each RFID tag attached to an object that was loaded into the storage space. The RFID reader receives the unique identifier from the RFID tag and sends the unique identifier to the transportation service provider to confirm the identity of each object loaded in the storage space in the autonomous vehicle. If a confirmed object is moved beyond the scanning range of the RFID reader (e.g., removed from the trunk), the RFID reader detects a lost RF signal and sends an alert code to the transportation service provider indicating that the object is no longer in the storage space. In this manner, objects are tracked with the autonomous vehicle and the passenger if the passenger is accompanying the objects in the autonomous vehicle.

When the autonomous vehicle arrives at the pick-up location within a scheduled pick-up time window, the transportation service provider computer system automatically unlocks the storage space (e.g., unlocks the trunk) and/or a container in the storage space of the autonomous vehicle. The storage space/container includes one or more sensors, including but not limited to: an RFID reader, x-ray scanner, infrared scanner, Terahertz radiation scanner, chemical signature analyzer, radiation detector, catalytic gas sensor, electrochemical sensor, photo ionization sensor, weighing scale, camera, ultrasound scanner, ion mobility spectrometer, surface acoustic wave (SAW) sensor, nuclear quadrupole resonance (NQR) sensor and a low intensity gamma radiation emitter and scintillation detector. These sensors scan and measure the physical characteristics of the object(s) to identify and localize the object(s) in the vehicle, and to determine if the object(s) are safe and legal for transport. In an embodiment, if hazardous materials or contraband are detected by the sensors, the autonomous vehicle can be disabled, and the authorities automatically alerted (e.g., automated phone call, email) of the violation. If the hazardous or contraband is stored in a locked container inside the storage space of the vehicle, the passenger can be prevented from opening the container. In an embodiment, the autonomous vehicle can be operated to navigate to a nearest police station.

In an embodiment, the autonomous vehicle is configured by the transportation service provider to refuse to transport objects unaccompanied by a passenger. At the pick-up location, and during the pick-up time window, the customer is required to authenticate with the transportation service computer system directly or indirectly through the autonomous vehicle. For example, the user can use their mobile device to send authentication information (e.g., password) and/or biometric data (e.g., a fingerprint, face or retina scan), together with location data, directly to the autonomous vehicle over a short-range wireless communication link (e.g., Bluetooth, NFC, WiFi), where the information and data can be authenticated locally by the autonomous vehicle computer system, or sent to the transportation service provider computer system for remote authentication and/or identity services. In an embodiment, a timestamp and location of the autonomous vehicle is combined with the customer's authentication data that is sent to the transportation service provider computer system to verify that the customer is co-located with the autonomous vehicle at the scheduled pick-up location and within the scheduled pick-up time window.

If the authentication fails, the transportation service provider computer system is alerted so that one or more actions can be initiated, including but not limited to: disabling or locking the autonomous vehicle (e.g., locking the storage space/container, locking the passenger doors), cancelling the reservation, navigating the vehicle to a different location (e.g., navigate to home base or the next scheduled pick-up location) and sending a communication to personal devices (e.g., smart phone, tablet computer, wearable computer) of the passengers with further instructions to remedy the issue, such as suggesting an alternative process for authentication (e.g., calling the transportation service by phone, a chat session through the website, text message, email, etc.).

Sensors inside/outside the passenger compartment of the autonomous vehicle (e.g., camera, biometric scanner, microphones) are used to confirm that the customer is present in the autonomous vehicle when it leaves the pick-up location, and also when the customer leaves the vehicle at the scheduled drop-off location or at an unscheduled location. If the customer leaves the autonomous vehicle at a schedule drop-off or unscheduled location, an alert is sent to the transportation service computer system, and to the passenger reminding the passenger to take their belongings from the storage space/container. When the RFID reader detects that the object has been removed from the storage space/container, the transportation service provider and/or passenger is alerted. In an embodiment, all activities associated with passenger/object ingress and egress to/from the autonomous vehicle are logged by the transportation service computer system for future retrieval. The log can be used to track lost objects, resolve customer disputes, provide evidence to law enforcement agencies and for any other desired purpose.

In an embodiment, where the customer has requested a shared vehicle (e.g., taxi or shuttle), the storage space may be configured with individual containers (e.g., cages, compartments, or other separators). The containers may be locked/unlocked with a key, combination, token, keypad, bar code, quick response (QR) code, wireless remote, etc., so that multiple passengers can safely store and retrieve their respective objects from their person containers without having access to objects belonging to other passengers. The autonomous vehicle may also secure the objects so that the objects are inaccessible until the passenger has arrived at the drop-off location. At the drop-off location, the transportation service provider computer system (or autonomous vehicle computer system) unlocks the storage space/container to allow the passenger to retrieve their objects. The transportation service provider computer system may then charge the customer an additional fee for additional objects or based on the physical characteristics of the luggage, or the customer make a payment using a point-of-sale (POS) payment system in the autonomous vehicle (e.g., using credit card reader). In an embodiment, the customer has an account set-up with the transportation service provider, and any fees are automatically charged to the customer.

The disclosed embodiment provide one or more of the following advantages. Customers can procure an autonomous vehicle that has sufficient capacity for transporting their luggage or cargo, but not too much capacity that would result in paying for overcapacity. The disclosed embodiments provide local and/or remote authentication of both passengers and their luggage/cargo at pick-up and drop-off locations, and unscheduled drop-offs/pick-ups while in route, to ensure that the system can track passengers and their luggage/cargo with the autonomous vehicle. Sensors in the vehicle storage space detect items that are hazardous or illegal to transport, and generates reports and alerts, or takes other actions (e.g., navigate to a police station or customs inspection site) when such items are detected. In an embodiment, the system allows passengers taking mass transit (e.g., traveling to an airport) to exit the vehicle at the departure terminal, and then automatically operate the vehicle to drive to a baggage claim/drop-off location, where the baggage can be inspected and processed by security before being loaded on a mass transit vehicle (e.g., an airplane).

These and other aspects, features, and implementations can be expressed as methods, apparatus, systems, components, program products, means or steps for performing a function, and in other ways.

These and other aspects, features, and implementations will become apparent from the following descriptions, including the claims.

### BRIEF DESCRIPTION OF THE DRAWINGS

FIG. 1 shows an example of an autonomous vehicle having autonomous capability.

FIG. 2 illustrates an example “cloud” computing environment.

FIG. 3 illustrates a computer system.

FIG. 4 shows an example architecture for an autonomous vehicle.

FIG. 5 shows an example of inputs and outputs that may be used by a perception module.

FIG. 6 shows an example of a LiDAR system.

FIG. 7 shows the LiDAR system in operation.

FIG. 8 shows the operation of the LiDAR system in additional detail.

FIG. 9 shows a block diagram of the relationships between inputs and outputs of a planning module.

FIG. 10 shows a directed graph used in path planning.

FIG. 11 shows a block diagram of the inputs and outputs of a control module.

FIG. 12 shows a block diagram of the inputs, outputs, and components of a controller.

FIG. 13 shows a system for procuring autonomous vehicles such as taxis, rental cars, moving vans and any other type of autonomous vehicle, including managing the transport of objects and/or passengers in the autonomous vehicles.

FIGS. 14A and 14B show the use of sensors to scan and measure objects in a storage space/container of an autonomous vehicle.

FIG. 15 shows the use of individually lockable storage containers for securely storing objects.

FIG. 16 shows a process performed by a transportation service provider computer system for managing the transportation of passengers and/or objects.

FIG. 17 shows a process performed by an autonomous vehicle computer system for managing the loading/unloading and transportation of passengers and/or objects.

FIG. 18 shows a process for detecting and reporting unsafe and/or contraband objects stored in autonomous vehicles.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:

1. General Overview

2. Hardware Overview

3. Autonomous Vehicle Architecture

4. Autonomous Vehicle Inputs

5. Autonomous Vehicle Planning

6. Autonomous Vehicle Control

7. Transporting Passengers/Objects Using Autonomous Vehicles

### General Overview

Techniques are provided for transporting objects using autonomous vehicles. In an embodiment, a computer system of a transportation service provider receives a request from a client device (e.g., desktop computer, mobile device, Kiosk) for an autonomous vehicle. The request includes a pick-up location, a drop-off location, a pick-up date, pick-up time window, customer information and descriptions of one or more objects (e.g., luggage, cargo) to be transported by the autonomous vehicle. The descriptions include but are not limited to: the number of objects, approximate physical characteristics (e.g., dimensions, color, weight, type) of each object. In an embodiment, a digital image of the object is transmitted by the customer (e.g., taken by a smartphone camera app) to the transportation service provider computer system. In an embodiment, a bar code, QR code or other unique identifier identifying each object is transmitted to the transportation service provider computer system. For example, the unique identifier can be attached to the object and then scanned using a bar code reader installed on the customer's smart phone or other mobile device.

The transportation service provider computer system searches an inventory database for an autonomous vehicle that is configured to transport the one or more objects based on the physical characteristics and other descriptive data for the one or more objects. For example, based on the physical characteristics and other descriptive data the computer system identifies one or more autonomous vehicles (e.g., passenger car, taxi, truck, van, bus) with sufficient storage space (e.g., square footage) and/or that meets a user-specified storage requirement (e.g., refrigerated storage, flammable liquid storage, flatbed). On the pick-up day, the transportation service computer system sends to the autonomous vehicle (e.g., using an over-the-air (OTA) communication system) computer system reservation details that includes the name of the passenger(s), pick-up date/pick-up time window, pick-up location, destination, a description of the objects (e.g., luggage, cargo) to be transported and other data (e.g., encryption key for authentication). In an embodiment where a passenger is not be transported with an object, the reservation details would not include passenger data or may include data regarding the customer who has requested the AV.

The transportation service provider computer system receives sensor data (e.g., raw or processed sensor data) from the autonomous vehicle at the pick-up location. The sensor data is generated by one or more sensors onboard the autonomous vehicle (e.g., an RFID scanner, a camera, an x-ray scanner, a microphone, a radiation meter, a chemical signature analyzer) located in the storage space/container and other locations (e.g., external cameras). The transportation service computer system (and/or the autonomous vehicle computer system) determines whether the one or more objects described by the sensor data matches the object descriptions (e.g., same physical dimensions of height, width, length, weight).

In accordance with the one or more objects matching their respective descriptions, the transportation service provider computer system (and/or the autonomous vehicle computer system) cause the autonomous vehicle to perform a first action (e.g., navigate to the destination), and in accordance with the one or more objects not matching the description, cause the autonomous vehicle to perform a second action (e.g., disable the vehicle, alert or drive to a police station or other authority, perform a “safe stop” maneuver).

In an embodiment, the description of the objects includes physical characteristics, such as height, length, width, weight or type of object (e.g., luggage, skis, plants, animals, perishables). For example, the transportation service provider computer system can determine, based on the description, an amount or type of storage space needed for the objects, and assign an autonomous vehicle with sufficient storage space for the objects based on the determined amount or type of needed storage space.

In an embodiment, the transportation service provider computer system receives one or more images of the object(s) from the autonomous vehicle computer system and determines, based on the one or more images, the size, weight or type of objects. One or more images can include a unique identifier (e.g., bar code or QR code on a luggage tag), such as a universally unique identifier (UUID) that associates the objects with the assigned autonomous vehicle and the customer or passenger.

In an embodiment, the transportation service computer system (and/or autonomous vehicle computer system) evaluate the description and the sensor data to determine if the objects are unsafe or illegal to transport (e.g., too hazardous or illegal to transport, but may be transportable with certain precautions undertaken, or with proper authorization or waiver). In accordance with the objects matching the description and being determined as safe and legal to transport, the autonomous vehicle is caused to perform a first action (e.g., navigate to the destination). In accordance with the objects not matching the description or not being safe and legal for transport, the autonomous vehicle is caused to perform a second action (e.g., disable the autonomous vehicle, drive to a police station or other authority).

In an embodiment, the transportation service provider computer system and/or autonomous computer system can use sensor data to determine that the objects are located in a storage space/container of the autonomous vehicle, and whether the objects include contraband (e.g., illegal drugs, smuggled goods). If the objects include contraband, the computer system locks the storage space and operates the autonomous vehicle to navigate to another destination (e.g., the closest police station), and/or sends an alert (e.g., email, text message, push notification, telephone call) to a third party (e.g., police department) that includes the location of the autonomous vehicle.

In an embodiment, a method comprises: receiving first authentication data (e.g., biometric data, password, passcode) from a first mobile device (e.g., a smart phone) operated by a first individual at the pick-up location; authenticating, based on the first authentication data, the first individual (e.g., using an identity service); associating the first individual with the object(s) and the assigned autonomous vehicle (e.g., associated using a relational database); receiving first location data from the autonomous vehicle indicating that the autonomous vehicle is at the pick-up location; receiving second location data from the mobile device associated with the first individual, the second location data indicating that the first individual is present at the pick-up location; and causing, the autonomous vehicle to unlock at least one storage compartment to allow loading of the object(s) (e.g., triggering a magnetic lock).

In an embodiment, the method further comprises: receiving third authentication data from a second mobile device operated by a second individual at the drop-off location; authenticating, based on the second authentication data, a second individual; associating the second individual with the object and the assigned autonomous vehicle; receiving third location data from the autonomous vehicle indicating that the autonomous vehicle is at the drop-off location; receiving fourth location data from the second mobile device associated with the second individual, the second location data indicating that the second individual is present at the drop-off location; and causing the autonomous vehicle to unlock one or more storage compartments to allow unloading of the object.

In an embodiment, the authentication data includes timestamped biometric data captured by the first or second mobile device (e.g., fingerprint, faceprint, voiceprint). In an embodiment, one or more storage containers are attached to the autonomous vehicle (e.g., lockable containers in a trunk or cargo bay of the autonomous vehicle), each having its own lock (e.g., keypad), and each assigned to a specific passenger or passengers in the autonomous vehicle. In an embodiment, the first and second individuals are the same individual, the first and second mobile devices are the same mobile device, and the individual is a passenger in the autonomous vehicle. In an embodiment, causing the autonomous vehicle to unlock its one or more storage containers, further comprises sending a security code to the first and second mobile devices, where the security code is for unlocking the one or more storage compartments using the first and second mobile devices.

In an embodiment, the transportation service provider and/or autonomous vehicle computer system determines that one or more passengers in the autonomous vehicle have disembarked from the autonomous vehicle at a transportation facility (e.g., an airport, mass transit terminal, train station, boat dock), and causes the autonomous vehicle to navigate to a designated area to drop-off the object(s) (e.g., a baggage check-in station, cargo loading facility, freight shipping facility). In an embodiment, the AV can share object data (e.g., number and type of suitcases) with a computer system operated by the transportation facility (e.g., a computer system for handling baggage), or share object data (e.g., x-ray scan, chemical analysis data) with a transportation security administration (TSA) computer system.

### Hardware Overview

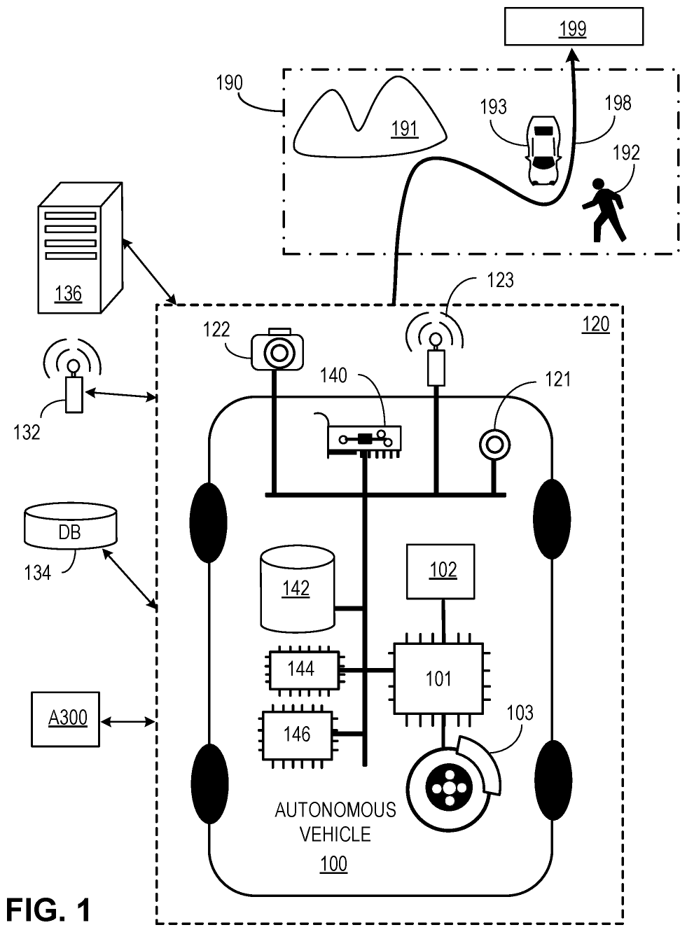

FIG. 1 shows an example of an autonomous vehicle 100 having autonomous capability.

As used herein, the term “autonomous capability” refers to a function, feature, or facility that enables a vehicle to be partially or fully operated without real-time human intervention, including without limitation fully autonomous vehicles, highly autonomous vehicles, and conditionally autonomous vehicles.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, etc. A driverless car is an example of a vehicle.

As used herein, “trajectory” refers to a path or route to navigate an AV from a first spatiotemporal location to second spatiotemporal location. In an embodiment, the first spatiotemporal location is referred to as the initial or starting location and the second spatiotemporal location is referred to as the destination, final location, goal, goal position, or goal location. In some examples, a trajectory is made up of one or more segments (e.g., sections of road) and each segment is made up of one or more blocks (e.g., portions of a lane or intersection). In an embodiment, the spatiotemporal locations correspond to real world locations. For example, the spatiotemporal locations are pick up or drop-off locations to pick up or drop-off persons or goods.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “scene description” is a data structure (e.g., list) or data stream that includes one or more classified or labeled objects detected by one or more sensors on the AV vehicle or provided by a source external to the AV.

As used herein, a “road” is a physical area that can be traversed by a vehicle, and may correspond to a named thoroughfare (e.g., city street, interstate freeway, etc.) or may correspond to an unnamed thoroughfare (e.g., a driveway in a house or office building, a section of a parking lot, a section of a vacant lot, a dirt path in a rural area, etc.). Because some vehicles (e.g., 4-wheel-drive pickup trucks, sport utility vehicles, etc.) are capable of traversing a variety of physical areas not specifically adapted for vehicle travel, a “road” may be a physical area not formally defined as a thoroughfare by any municipality or other governmental or administrative body.

As used herein, a “lane” is a portion of a road that can be traversed by a vehicle. A lane is sometimes identified based on lane markings. For example, a lane may correspond to most or all of the space between lane markings, or may correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings, or having two lanes between the lane markings. A lane could also be interpreted in the absence of lane markings. For example, a lane may be defined based on physical features of an environment, e.g., rocks and trees along a thoroughfare in a rural area or, e.g., natural obstructions to be avoided in an undeveloped area. A lane could also be interpreted independent of lane markings or physical features. For example, a lane could be interpreted based on an arbitrary path free of obstructions in an area that otherwise lacks features that would be interpreted as lane boundaries. In an example scenario, an AV could interpret a lane through an obstruction-free portion of a field or empty lot. In another example scenario, an AV could interpret a lane through a wide (e.g., wide enough for two or more lanes) road that does not have lane markings. In this scenario, the AV could communicate information about the lane to other AVs so that the other AVs can use the same lane information to coordinate path planning among themselves.

The term “over-the-air (OTA) client” includes any AV, or any electronic device (e.g., computer, controller, IoT device, electronic control unit (ECU)) that is embedded in, coupled to, or in communication with an AV.

The term “over-the-air (OTA) update” means any update, change, deletion or addition to software, firmware, data or configuration settings, or any combination thereof, that is delivered to an OTA client using proprietary and/or standardized wireless communications technology, including but not limited to: cellular mobile communications (e.g., 2G, 3G, 4G, 5G), radio wireless area networks (e.g., WiFi) and/or satellite Internet.

The term “edge node” means one or more edge devices coupled to a network that provide a portal for communication with AVs and can communicate with other edge nodes and a cloud based computing platform, for scheduling and delivering OTA updates to OTA clients.

The term “edge device” means a device that implements an edge node and provides a physical wireless access point (AP) into enterprise or service provider (e.g., Verizon®, AT&T®) core networks. Examples of edge devices include but are not limited to: computers, controllers, transmitters, routers, routing switches, integrated access devices (IADs), multiplexers, metropolitan area network (MAN) and wide area network (WAN) access devices.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

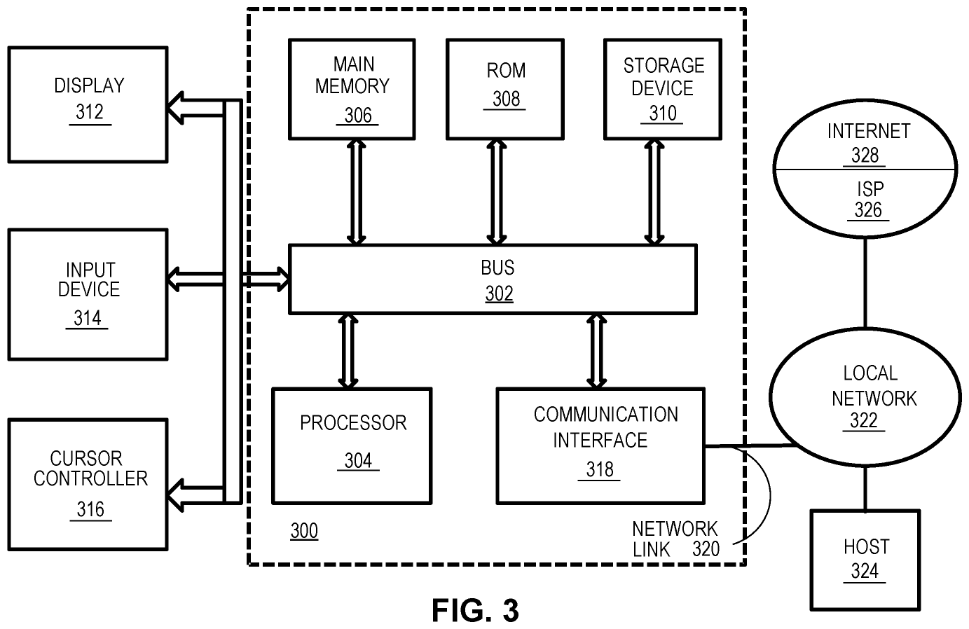

As used herein, an AV system refers to the AV along with the array of hardware, software, stored data, and data generated in real-time that supports the operation of the AV. In an embodiment, the AV system is incorporated within the AV. In an embodiment, the AV system is spread across several locations. For example, some of the software of the AV system is implemented on a cloud computing environment similar to cloud computing environment 300 described below with respect to FIG. 3.

In general, this document describes technologies applicable to any vehicles that have one or more autonomous capabilities including fully autonomous vehicles, highly autonomous vehicles, and conditionally autonomous vehicles, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). The technologies described in this document are also applicable to partially autonomous vehicles and driver assisted vehicles, such as so-called Level 2 and Level 1 vehicles (see SAE International's standard J3016: Taxonomy and Definitions for Terms Related to On-Road Motor Vehicle Automated Driving Systems). In an embodiment, one or more of the Level 1, 2, 3, 4 and 5 vehicle systems may automate certain vehicle operations (e.g., steering, braking, and using maps) under certain operating conditions based on processing of sensor inputs. The technologies described in this document can benefit vehicles in any levels, ranging from fully autonomous vehicles to human-operated vehicles.

Autonomous vehicles have advantages over vehicles that require a human driver. One advantage is safety. For example, in 2016, the United States experienced 6 million automobile accidents, 2.4 million injuries, 40,000 fatalities, and 13 million vehicles in crashes, estimated at a societal cost of $910+ billion. U.S. traffic fatalities per 100 million miles traveled have been reduced from about six to about one from 1965 to 2015, in part due to additional safety measures deployed in vehicles. For example, an additional half second of warning that a crash is about to occur is believed to mitigate 60% of front-to-rear crashes. However, passive safety features (e.g., seat belts, airbags) have likely reached their limit in improving this number. Thus, active safety measures, such as automated control of a vehicle, are the likely next step in improving these statistics. Because human drivers are believed to be responsible for a critical pre-crash event in 95% of crashes, automated driving systems are likely to achieve better safety outcomes, e.g., by reliably recognizing and avoiding critical situations better than humans; making better decisions, obeying traffic laws, and predicting future events better than humans; and reliably controlling a vehicle better than a human.

Referring to FIG. 1, an AV system 120 operates the AV 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

In an embodiment, the AV system 120 includes devices 101 that are instrumented to receive and act on operational commands from the computer processors 146. In an embodiment, computing processors 146 are similar to the processor 304 described below in reference to FIG. 3. Examples of devices 101 include a steering control 102, brakes 103, gears, accelerator pedal or other acceleration control mechanisms, windshield wipers, side-door locks, window controls, and turn-indicators.

In an embodiment, the AV system 120 includes sensors 121 for measuring or inferring properties of state or condition of the AV 100, such as the AV's position, linear and angular velocity and acceleration, and heading (e.g., an orientation of the leading end of AV 100). Example of sensors 121 include but are not limited to: Global Navigation Satellite System (GNSS), inertial measurement units (IMU) that measure both vehicle linear accelerations and angular rates, wheel speed sensors for measuring or estimating wheel slip ratios, wheel brake pressure or braking torque sensors, engine torque or wheel torque sensors, and steering angle and angular rate sensors.

In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In an embodiment, the AV system 120 includes a data storage unit 142 and memory 144 for storing machine instructions associated with computer processors 146 or data collected by sensors 121. In an embodiment, the data storage unit 142 is similar to the ROM 308 or storage device 310 described below in relation to FIG. 3. In an embodiment, memory 144 is similar to the main memory 306 described below. In an embodiment, the data storage unit 142 and memory 144 store historical, real-time, and/or predictive information about the environment 190. In an embodiment, the stored information includes maps, driving performance, traffic congestion updates or weather conditions. In an embodiment, data relating to the environment 190 is transmitted to the AV 100 via a communications channel from a remotely located database 134.

In an embodiment, the AV system 120 includes communications devices 140 for communicating measured or inferred properties of other vehicles' states and conditions, such as positions, linear and angular velocities, linear and angular accelerations, and linear and angular headings to the AV 100. These devices include Vehicle-to-Vehicle (V2V) and Vehicle-to-Infrastructure (V2I) communication devices and devices for wireless communications over point-to-point or ad hoc networks or both. In an embodiment, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in some embodiments, one or more other types of communication) is sometimes referred to as Vehicle-to-Everything (V2X) communication. V2X communication typically conforms to one or more communications standards for communication with, between, and among autonomous vehicles.

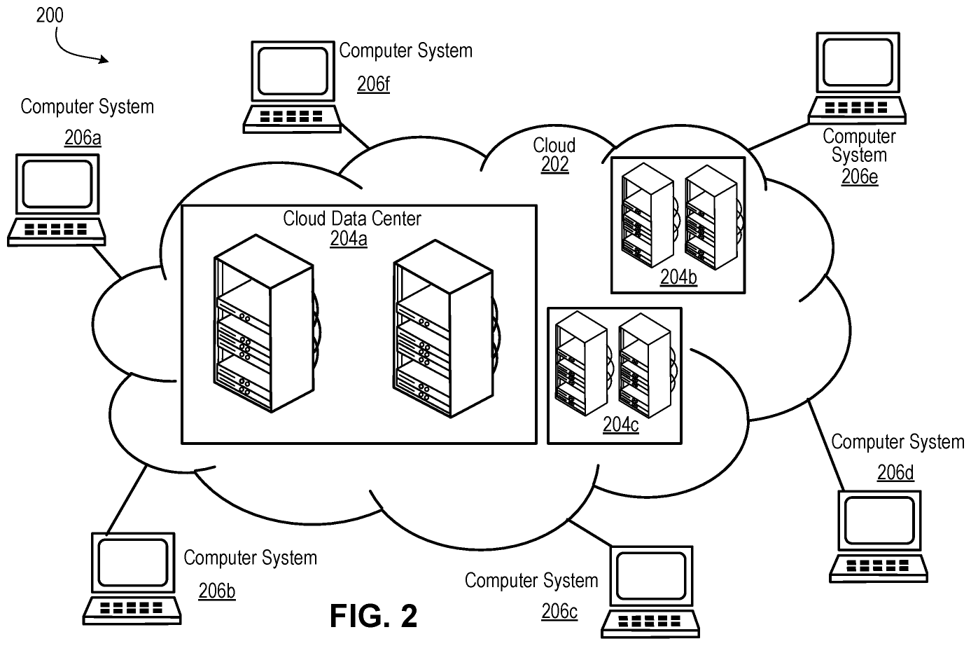

In an embodiment, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In an embodiment, the remotely located database 134 is embedded in a cloud computing environment 200 as described in FIG. 2. The communication interfaces 140 transmit data collected from sensors 121 or other data related to the operation of AV 100 to the remotely located database 134. In an embodiment, communication interfaces 140 transmit information that relates to teleoperations to the AV 100. In some embodiments, the AV 100 communicates with other remote (e.g., “cloud”) servers 136.

In an embodiment, the remotely located database 134 also stores and transmits digital data (e.g., storing data such as road and street locations). Such data is stored on the memory 144 on the AV 100, or transmitted to the AV 100 via a communications channel from the remotely located database 134.

In an embodiment, the remotely located database 134 stores and transmits historical information about driving properties (e.g., speed and acceleration profiles) of vehicles that have previously traveled along trajectory 198 at similar times of day. In one implementation, such data may be stored on the memory 144 on the AV 100, or transmitted to the AV 100 via a communications channel from the remotely located database 134.

Computing devices 146 located on the AV 100 algorithmically generate control actions based on both real-time sensor data and prior information, allowing the AV system 120 to execute its autonomous driving capabilities.

In an embodiment, the AV system 120 includes computer peripherals 132 coupled to computing devices 146 for providing information and alerts to, and receiving input from, a user (e.g., an occupant or a remote user) of the AV 100. In an embodiment, peripherals 132 are similar to the display 312, input device 314, and cursor controller 316 discussed below in reference to FIG. 3. The coupling is wireless or wired. Any two or more of the interface devices may be integrated into a single device.

FIG. 2 illustrates an example “cloud” computing environment. Cloud computing is a model of service delivery for enabling convenient, on-demand network access to a shared pool of configurable computing resources (e.g. networks, network bandwidth, servers, processing, memory, storage, applications, virtual machines, and services). In typical cloud computing systems, one or more large cloud data centers house the machines used to deliver the services provided by the cloud. Referring now to FIG. 2, the cloud computing environment 200 includes cloud data centers 204a, 204b, and 204c that are interconnected through the cloud 202. Data centers 204a, 204b, and 204c provide cloud computing services to computer systems 206a, 206b, 206c, 206d, 206e, and 206f connected to cloud 202.

The cloud computing environment 200 includes one or more cloud data centers. In general, a cloud data center, for example the cloud data center 204a shown in FIG. 2, refers to the physical arrangement of servers that make up a cloud, for example the cloud 202 shown in FIG. 2, or a particular portion of a cloud. For example, servers are physically arranged in the cloud datacenter into rooms, groups, rows, and racks. A cloud datacenter has one or more zones, which include one or more rooms of servers. Each room has one or more rows of servers, and each row includes one or more racks. Each rack includes one or more individual server nodes. In some implementation, servers in zones, rooms, racks, and/or rows are arranged into groups based on physical infrastructure requirements of the datacenter facility, which include power, energy, thermal, heat, and/or other requirements. In an embodiment, the server nodes are similar to the computer system described in FIG. 3. The data center 204a has many computing systems distributed through many racks.

The cloud 202 includes cloud data centers 204a, 204b, and 204c along with the network and networking resources (for example, networking equipment, nodes, routers, switches, and networking cables) that interconnect the cloud data centers 204a, 204b, and 204c and help facilitate the computing systems' 206a-f access to cloud computing services. In an embodiment, the network represents any combination of one or more local networks, wide area networks, or internetworks coupled using wired or wireless links deployed using terrestrial or satellite connections. Data exchanged over the network, is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In some embodiments, the network represents one or more interconnected internetworks, such as the public Internet.

The computing systems 206a-f or cloud computing services consumers are connected to the cloud 202 through network links and network adapters. In an embodiment, the computing systems 206a-f are implemented as various computing devices, for example servers, desktops, laptops, tablet, smartphones, Internet of Things (IoT) devices, autonomous vehicles (including, cars, drones, shuttles, trains, buses, etc.) and consumer electronics. In an embodiment, the computing systems 206a-f are implemented in or as a part of other systems.

FIG. 3 illustrates a computer system 300. In an implementation, the computer system 300 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In an embodiment, the computer system 300 includes a bus 302 or other communication mechanism for communicating information, and a hardware processor 304 coupled with a bus 302 for processing information. The hardware processor 304 is, for example, a general-purpose microprocessor. The computer system 300 also includes a main memory 306, such as a random-access memory (RAM) or other dynamic storage device, coupled to the bus 302 for storing information and instructions to be executed by processor 304. In one implementation, the main memory 306 is used for storing temporary variables or other intermediate information during execution of instructions to be executed by the processor 304. Such instructions, when stored in non-transitory storage media accessible to the processor 304, render the computer system 300 into a special-purpose machine that is customized to perform the operations specified in the instructions.

In an embodiment, the computer system 300 further includes a read only memory (ROM) 308 or other static storage device coupled to the bus 302 for storing static information and instructions for the processor 304. A storage device 310, such as a magnetic disk, optical disk, solid-state drive, or three-dimensional cross point memory is provided and coupled to the bus 302 for storing information and instructions.

In an embodiment, the computer system 300 is coupled via the bus 302 to a display 312, such as a cathode ray tube (CRT), a liquid crystal display (LCD), plasma display, light emitting diode (LED) display, or an organic light emitting diode (OLED) display for displaying information to a computer user. An input device 314, including alphanumeric and other keys, is coupled to bus 302 for communicating information and command selections to the processor 304. Another type of user input device is a cursor controller 316, such as a mouse, a trackball, a touch-enabled display, or cursor direction keys for communicating direction information and command selections to the processor 304 and for controlling cursor movement on the display 312. This input device typically has two degrees of freedom in two axes, a first axis (e.g., x-axis) and a second axis (e.g., y-axis), that allows the device to specify positions in a plane.

According to one embodiment, the techniques herein are performed by the computer system 300 in response to the processor 304 executing one or more sequences of one or more instructions contained in the main memory 306. Such instructions are read into the main memory 306 from another storage medium, such as the storage device 310. Execution of the sequences of instructions contained in the main memory 306 causes the processor 304 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 310. Volatile media includes dynamic memory, such as the main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that comprise the bus 302. Transmission media can also take the form of acoustic or light waves, such as those generated during radio-wave and infrared data communications.

In an embodiment, various forms of media are involved in carrying one or more sequences of one or more instructions to the processor 304 for execution. For example, the instructions are initially carried on a magnetic disk or solid-state drive of a remote computer. The remote computer loads the instructions into its dynamic memory and send the instructions over a telephone line using a modem. A modem local to the computer system 300 receives the data on the telephone line and use an infrared transmitter to convert the data to an infrared signal. An infrared detector receives the data carried in the infrared signal and appropriate circuitry places the data on the bus 302. The bus 302 carries the data to the main memory 306, from which processor 304 retrieves and executes the instructions. The instructions received by the main memory 306 may optionally be stored on the storage device 310 either before or after execution by processor 304.

The computer system 300 also includes a communication interface 318 coupled to the bus 302. The communication interface 318 provides a two-way data communication coupling to a network link 320 that is connected to a local network 322. For example, the communication interface 318 is an integrated service digital network (ISDN) card, cable modem, satellite modem, or a modem to provide a data communication connection to a corresponding type of telephone line. As another example, the communication interface 318 is a local area network (LAN) card to provide a data communication connection to a compatible LAN. In some implementations, wireless links are also implemented. In any such implementation, the communication interface 318 sends and receives electrical, electromagnetic, or optical signals that carry digital data streams representing various types of information.

The network link 320 typically provides data communication through one or more networks to other data devices. For example, the network link 320 provides a connection through the local network 322 to a host computer 324 or to a cloud data center or equipment operated by an Internet Service Provider (ISP) 326. The ISP 326 in turn provides data communication services through the world-wide packet data communication network now commonly referred to as the “Internet” 328. The local network 322 and Internet 328 both use electrical, electromagnetic or optical signals that carry digital data streams. The signals through the various networks and the signals on the network link 320 and through the communication interface 318, which carry the digital data to and from the computer system 300, are example forms of transmission media. In an embodiment, the network 320 contains the cloud 202 or a part of the cloud 202 described above.

The computer system 300 sends messages and receives data, including program code, through the network(s), the network link 320, and the communication interface 318. In an embodiment, the computer system 300 receives code for processing. The received code is executed by the processor 304 as it is received, and/or stored in storage device 310, or other non-volatile storage for later execution.

### Autonomous Vehicle Architecture

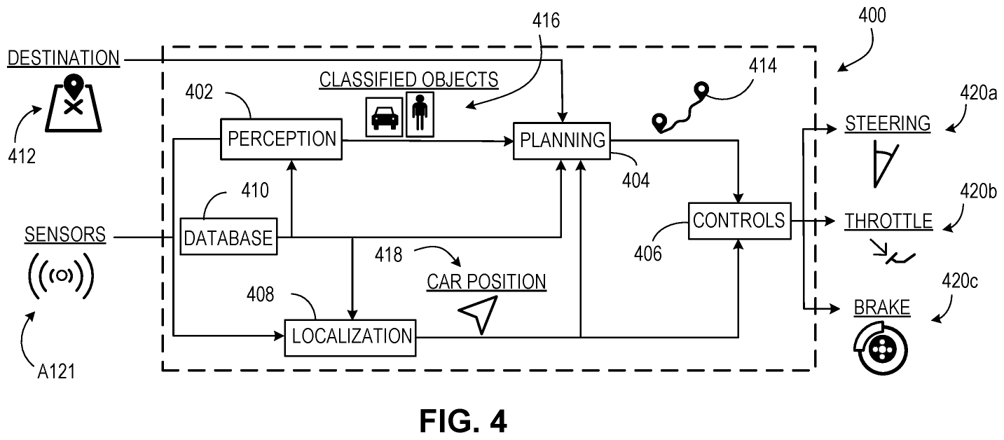

FIG. 4 shows an example architecture 400 for an autonomous vehicle (e.g., the AV 100 shown in FIG. 1). The architecture 400 includes a perception module 402 (sometimes referred to as a perception circuit), a planning module 404 (sometimes referred to as a planning circuit), a control module 406 (sometimes referred to as a control circuit), a localization module 408 (sometimes referred to as a localization circuit), and a database module 410 (sometimes referred to as a database circuit). Each module plays a role in the operation of the AV 100. Together, the modules 402, 404, 406, 408, and 410 may be part of the AV system 120 shown in FIG. 1. In some embodiments, any of the modules 402, 404, 406, 408, and 410 is a combination of computer software (e.g., executable code stored on a computer-readable medium) and computer hardware (e.g., one or more microprocessors, microcontrollers, application-specific integrated circuits [ASICs]), hardware memory devices, other types of integrated circuits, other types of computer hardware, or a combination of any or all of these things). Each of the modules 402, 404, 406, 408, and 410 is sometimes referred to as a processing circuit (e.g., computer hardware, computer software, or a combination of the two). A combination of any or all of the modules 402, 404, 406, 408, and 410 is also an example of a processing circuit.

In use, the planning module 404 receives data representing a destination 412 and determines data representing a trajectory 414 (sometimes referred to as a route) that can be traveled by the AV 100 to reach (e.g., arrive at) the destination 412. In order for the planning module 404 to determine the data representing the trajectory 414, the planning module 404 receives data from the perception module 402, the localization module 408, and the database module 410.

The perception module 402 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 416 is provided to the planning module 404.

The planning module 404 also receives data representing the AV position 418 from the localization module 408. The localization module 408 determines the AV position by using data from the sensors 121 and data from the database module 410 (e.g., a geographic data) to calculate a position. For example, the localization module 408 uses data from a GNSS (Global Navigation Satellite System) sensor and geographic data to calculate a longitude and latitude of the AV. In an embodiment, data used by the localization module 408 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types. In an embodiment, the high -precision maps are constructed by adding data through automatic or manual annotation to low-precision maps.

The control module 406 receives the data representing the trajectory 414 and the data representing the AV position 418 and operates the control functions 420a-c (e.g., steering, throttling, braking, and ignition) of the AV in a manner that will cause the AV 100 to travel the trajectory 414 to the destination 412. For example, if the trajectory 414 includes a left turn, the control module 406 will operate the control functions 420a-c in a manner such that the steering angle of the steering function will cause the AV 100 to turn left and the throttling and braking will cause the AV 100 to pause and wait for passing pedestrians or vehicles before the turn is made.

### Autonomous Vehicle Inputs

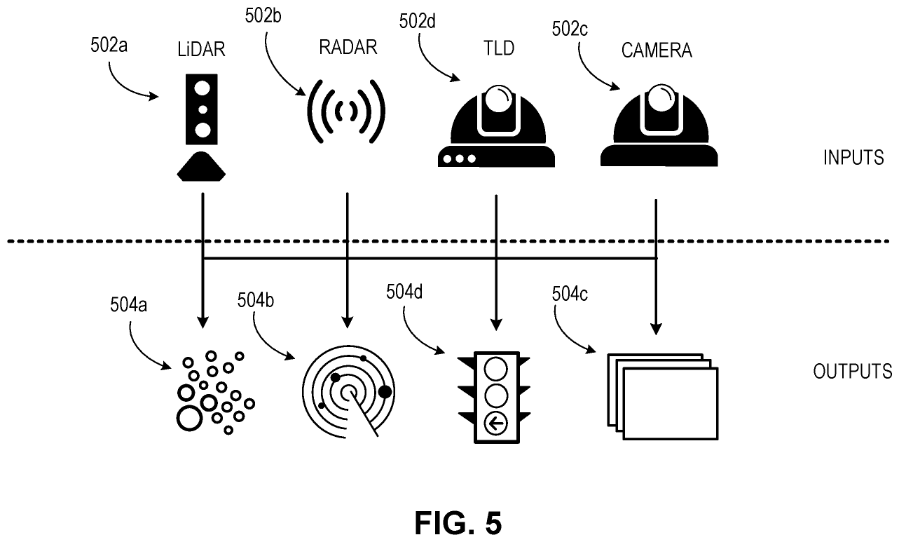

FIG. 5 shows an example of inputs 502a-d (e.g., sensors 121 shown in FIG. 1) and outputs 504a-d (e.g., sensor data) that is used by the perception module 402 (FIG. 4). One input 502a is a LiDAR (Light Detection and Ranging) system (e.g., LiDAR 123 shown in FIG. 1). LiDAR is a technology that uses light (e.g., bursts of light such as infrared light) to obtain data about physical objects in its line of sight. A LiDAR system produces LiDAR data as output 504a. For example, LiDAR data is collections of 3D or 2D points (also known as a point clouds) that are used to construct a representation of the environment 190.

Another input 502b is a RADAR system. RADAR is a technology that uses radio waves to obtain data about nearby physical objects. RADARs can obtain data about objects not within the line of sight of a LiDAR system. A RADAR system 502b produces RADAR data as output 504b. For example, RADAR data are one or more radio frequency electromagnetic signals that are used to construct a representation of the environment 190.

Another input 502c is a camera system. A camera system uses one or more cameras (e.g., digital cameras using a light sensor such as a charge-coupled device [CCD]) to obtain information about nearby physical objects. A camera system produces camera data as output 504c. Camera data often takes the form of image data (e.g., data in an image data format such as RAW, JPEG, PNG, etc.). In some examples, the camera system has multiple independent cameras, e.g., for the purpose of stereopsis (stereo vision), which enables the camera system to perceive depth. Although the objects perceived by the camera system are described here as “nearby,” this is relative to the AV. In use, the camera system may be configured to “see” objects far, e.g., up to a kilometer or more ahead of the AV. Accordingly, the camera system may have features such as sensors and lenses that are optimized for perceiving objects that are far away.

Another input 502d is a traffic light detection (TLD) system. A TLD system uses one or more cameras to obtain information about traffic lights, street signs, and other physical objects that provide visual navigation information. A TLD system produces TLD data as output 504d. TLD data often takes the form of image data (e.g., data in an image data format such as RAW, JPEG, PNG, etc.). A TLD system differs from a system incorporating a camera in that a TLD system uses a camera with a wide field of view (e.g., using a wide-angle lens or a fish-eye lens) in order to obtain information about as many physical objects providing visual navigation information as possible, so that the AV 100 has access to all relevant navigation information provided by these objects. For example, the viewing angle of the TLD system may be about 120 degrees or more.

In some embodiments, outputs 504a-d are combined using a sensor fusion technique. Thus, either the individual outputs 504a-d are provided to other systems of the AV 100 (e.g., provided to a planning module 404 as shown in FIG. 4), or the combined output can be provided to the other systems, either in the form of a single combined output or multiple combined outputs of the same type (e.g., using the same combination technique or combining the same outputs or both) or different types type (e.g., using different respective combination techniques or combining different respective outputs or both). In some embodiments, an early fusion technique is used. An early fusion technique is characterized by combining outputs before one or more data processing steps are applied to the combined output. In some embodiments, a late fusion technique is used. A late fusion technique is characterized by combining outputs after one or more data processing steps are applied to the individual outputs.

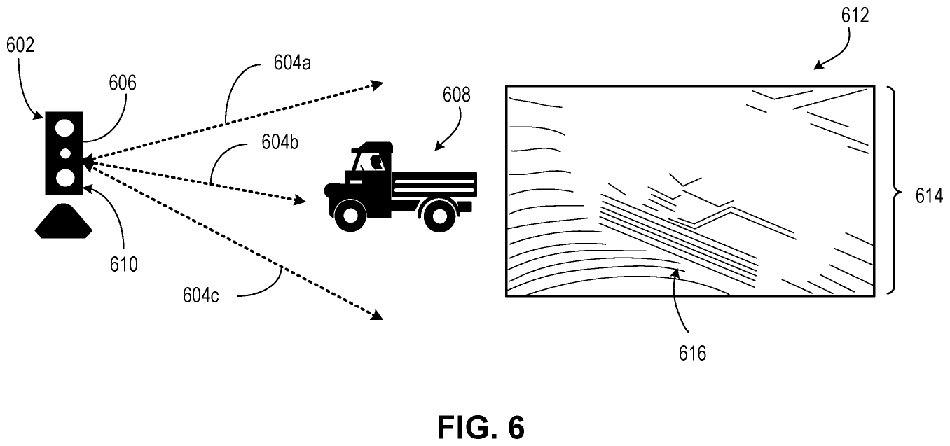

FIG. 6 shows an example of a LiDAR system 602 (e.g., the input 502a shown in FIG. 5). The LiDAR system 602 emits light 604a-c from a light emitter 606 (e.g., a laser transmitter). Light emitted by a LiDAR system is typically not in the visible spectrum; for example, infrared light is often used. Some of the light 604b emitted encounters a physical object 608 (e.g., a vehicle) and reflects back to the LiDAR system 602. (Light emitted from a LiDAR system typically does not penetrate physical objects, e.g., physical objects in solid form.) The LiDAR system 602 also has one or more light detectors 610, which detect the reflected light. In an embodiment, one or more data processing systems associated with the LiDAR system generates an image 612 representing the field of view 614 of the LiDAR system. The image 612 includes information that represents the boundaries 616 of a physical object 608. In this way, the image 612 is used to determine the boundaries 616 of one or more physical objects near an AV.

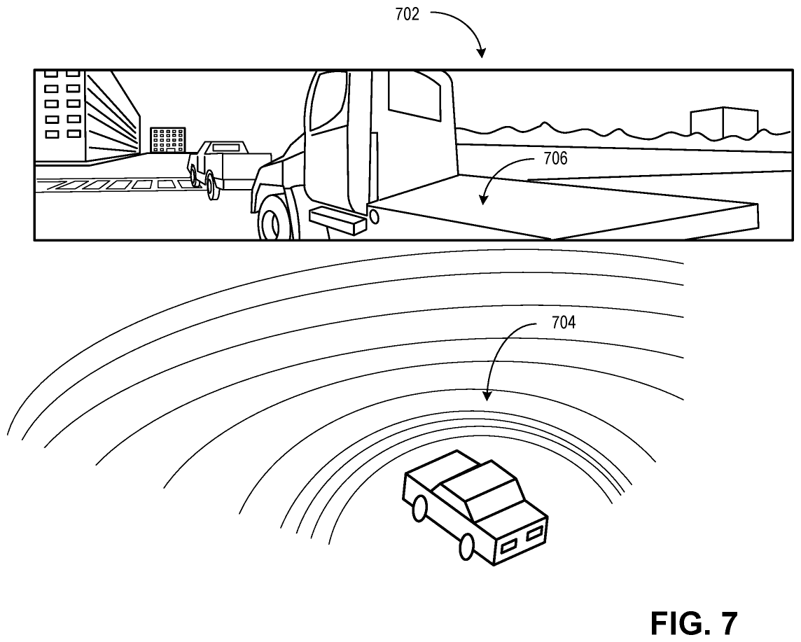

FIG. 7 shows the LiDAR system 602 in operation. In the scenario shown in this figure, the AV 100 receives both camera system output 504c in the form of an image 702 and LiDAR system output 504a in the form of LiDAR data points 704. In use, the data processing systems of the AV 100 compares the image 702 to the data points 704. In particular, a physical object 706 identified in the image 702 is also identified among the data points 704. In this way, the AV 100 perceives the boundaries of the physical object based on the contour and density of the data points 704.

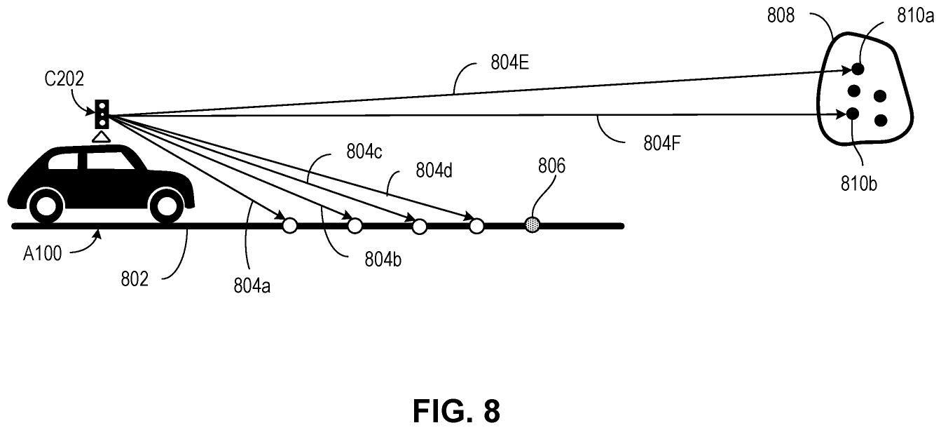

FIG. 8 shows the operation of the LiDAR system 602 in additional detail. As described above, the AV 100 detects the boundary of a physical object based on characteristics of the data points detected by the LiDAR system 602. As shown in FIG. 8, a flat object, such as the ground 802, will reflect light 804a-d emitted from a LiDAR system 602 in a consistent manner. Put another way, because the LiDAR system 602 emits light using consistent spacing, the ground 802 will reflect light back to the LiDAR system 602 with the same consistent spacing. As the AV 100 travels over the ground 802, the LiDAR system 602 will continue to detect light reflected by the next valid ground point 806 if nothing is obstructing the road. However, if an object 808 obstructs the road, light 804e-f emitted by the LiDAR system 602 will be reflected from points 810a-b in a manner inconsistent with the expected consistent manner. From this information, the AV 100 can determine that the object 808 is present.

### Path Planning

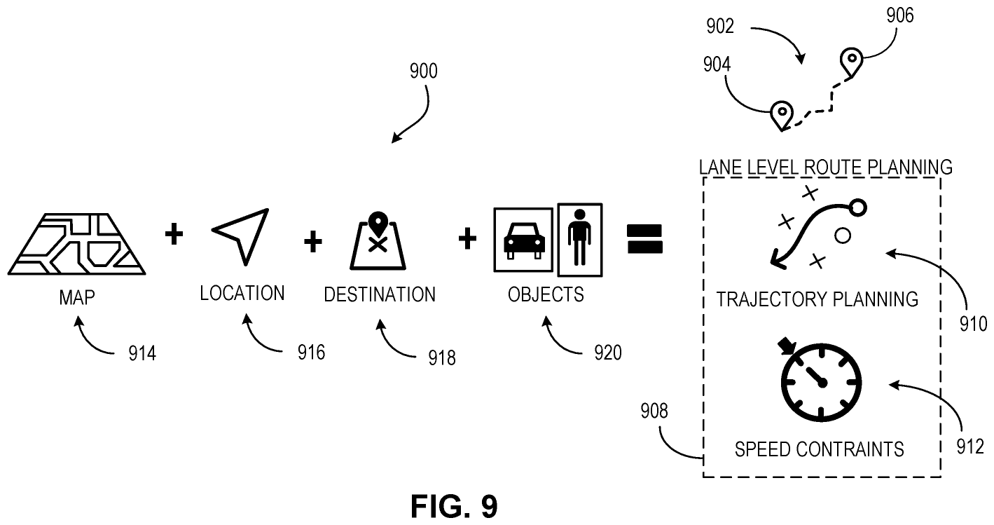

FIG. 9 shows a block diagram 900 of the relationships between inputs and outputs of a planning module 404 (e.g., as shown in FIG. 4). In general, the output of a planning module 404 is a route 902 from a start point 904 (e.g., source location or initial location), and an end point 906 (e.g., destination or final location). The route 902 is typically defined by one or more segments. For example, a segment is a distance to be traveled over at least a portion of a street, road, highway, driveway, or other physical area appropriate for automobile travel. In some examples, e.g., if the AV 100 is an off-road capable vehicle such as a four-wheel-drive (4WD) or all-wheel-drive (AWD) car, SUV, pick-up truck, or the like, the route 902 includes “off-road” segments such as unpaved paths or open fields.

In addition to the route 902, a planning module also outputs lane-level route planning data 908. The lane-level route planning data 908 is used to traverse segments of the route 902 based on conditions of the segment at a particular time. For example, if the route 902 includes a multi-lane highway, the lane-level route planning data 908 includes trajectory planning data 910 that the AV 100 can use to choose a lane among the multiple lanes, e.g., based on whether an exit is approaching, whether one or more of the lanes have other vehicles, or other factors that vary over the course of a few minutes or less. Similarly, in some implementations, the lane-level route planning data 908 includes speed constraints 912 specific to a segment of the route 902. For example, if the segment includes pedestrians or un-expected traffic, the speed constraints 912 may limit the AV 100 to a travel speed slower than an expected speed, e.g., a speed based on speed limit data for the segment.

In an embodiment, the inputs to the planning module 404 includes database data 914 (e.g., from the database module 410 shown in FIG. 4), current location data 916 (e.g., the AV position 418 shown in FIG. 4), destination data 918 (e.g., for the destination 412 shown in FIG. 4), and object data 920 (e.g., the classified objects 416 as perceived by the perception module 402 as shown in FIG. 4). In some embodiments, the database data 914 includes rules used in planning. Rules are specified using a formal language, e.g., using Boolean logic. In any given situation encountered by the AV 100, at least some of the rules will apply to the situation. A rule applies to a given situation if the rule has conditions that are met based on information available to the AV 100, e.g., information about the surrounding environment. Rules can have priority. For example, a rule that says “if the road is a freeway, move to the leftmost lane” can have a lower priority than “if the exit is approaching within a mile, move to the rightmost lane.”

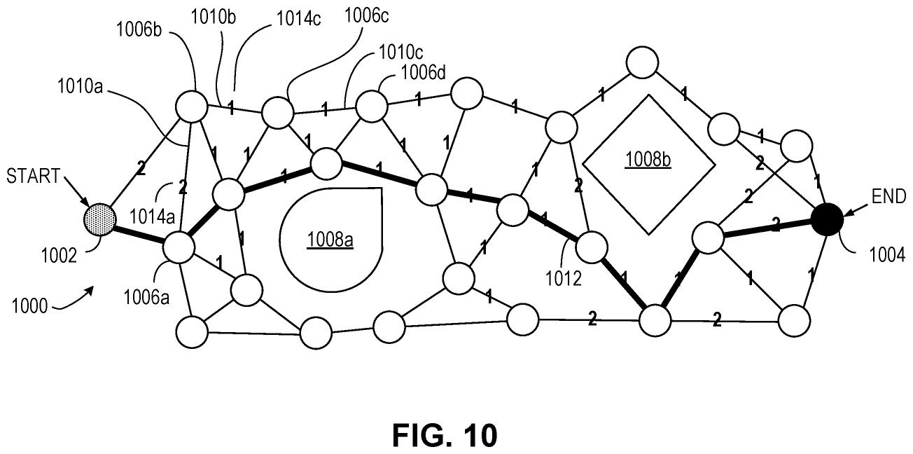

FIG. 10 shows a directed graph 1000 used in path planning, e.g., by the planning module 404 (FIG. 4). In general, a directed graph 1000 like the one shown in FIG. 10 is used to determine a path between any start point 1002 and end point 1004. In real-world terms, the distance separating the start point 1002 and end point 1004 may be relatively large (e.g., in two different metropolitan areas) or may be relatively small (e.g., two intersections abutting a city block or two lanes of a multi-lane road).

In an embodiment, the directed graph 1000 has nodes 1006a-d representing different locations between the start point 1002 and the end point 1004 that could be occupied by an AV 100. In some examples, e.g., when the start point 1002 and end point 1004 represent different metropolitan areas, the nodes 1006a-d represent segments of roads. In some examples, e.g., when the start point 1002 and the end point 1004 represent different locations on the same road, the nodes 1006a-d represent different positions on that road. In this way, the directed graph 1000 includes information at varying levels of granularity. In an embodiment, a directed graph having high granularity is also a subgraph of another directed graph having a larger scale. For example, a directed graph in which the start point 1002 and the end point 1004 are far away (e.g., many miles apart) has most of its information at a low granularity and is based on stored data, but also includes some high granularity information for the portion of the graph that represents physical locations in the field of view of the AV 100.

The nodes 1006a-d are distinct from objects 1008a-b which cannot overlap with a node. In an embodiment, when granularity is low, the objects 1008a-b represent regions that cannot be traversed by automobile, e.g., areas that have no streets or roads. When granularity is high, the objects 1008a-b represent physical objects in the field of view of the AV 100, e.g., other automobiles, pedestrians, or other entities with which the AV 100 cannot share physical space. In an embodiment, some or all of the objects 1008a-b are a static objects (e.g., an object that does not change position such as a street lamp or utility pole) or dynamic objects (e.g., an object that is capable of changing position such as a pedestrian or other car).

The nodes 1006a-d are connected by edges 1010a-c. If two nodes 1006a-b are connected by an edge 1010a, it is possible for an AV 100 to travel between one node 1006a and the other node 1006b, e.g., without having to travel to an intermediate node before arriving at the other node 1006b. (When we refer to an AV 100 traveling between nodes, we mean that the AV 100 travels between the two physical positions represented by the respective nodes.) The edges 1010a-c are often bidirectional, in the sense that an AV 100 travels from a first node to a second node, or from the second node to the first node. In an embodiment, edges 1010a-c are unidirectional, in the sense that an AV 100 can travel from a first node to a second node, however the AV 100 cannot travel from the second node to the first node. Edges 1010a-c are unidirectional when they represent, for example, one-way streets, individual lanes of a street, road, or highway, or other features that can only be traversed in one direction due to legal or physical constraints.

In an embodiment, the planning module 404 uses the directed graph 1000 to identify a path 1012 made up of nodes and edges between the start point 1002 and end point 1004.

An edge 1010a-c has an associated cost 1014a-b. The cost 1014a-b is a value that represents the resources that will be expended if the AV 100 chooses that edge. A typical resource is time. For example, if one edge 1010a represents a physical distance that is twice that as another edge 1010b, then the associated cost 1014a of the first edge 1010a may be twice the associated cost 1014b of the second edge 1010b. Other factors that affect time include expected traffic, number of intersections, speed limit, etc. Another typical resource is fuel economy. Two edges 1010a-b may represent the same physical distance, but one edge 1010a may require more fuel than another edge 1010b, e.g., because of road conditions, expected weather, etc.

When the planning module 404 identifies a path 1012 between the start point 1002 and end point 1004, the planning module 404 typically chooses a path optimized for cost, e.g., the path that has the least total cost when the individual costs of the edges are added together.

### Autonomous Vehicle Control

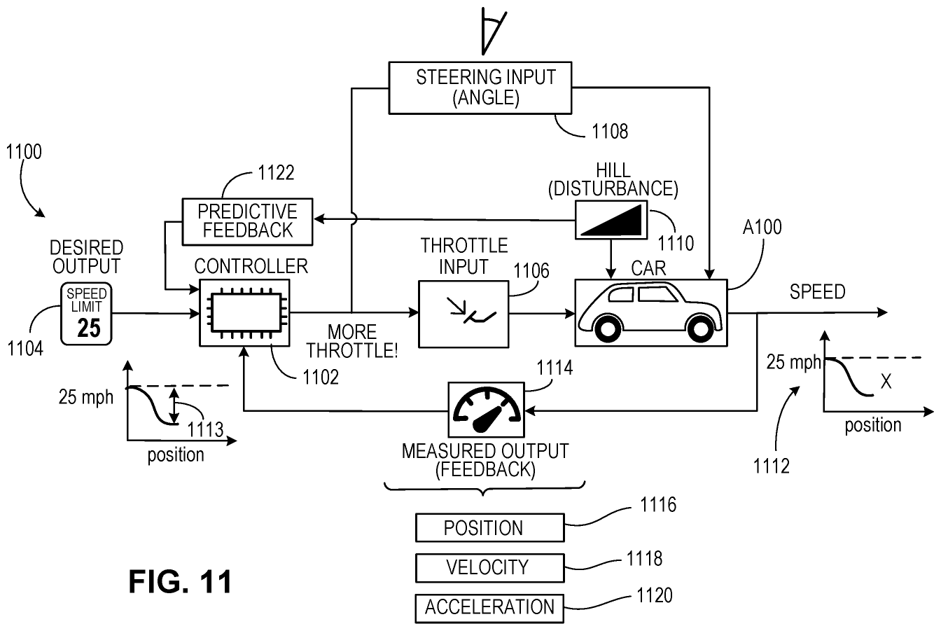

FIG. 11 shows a block diagram 1100 of the inputs and outputs of a control module 406 (e.g., as shown in FIG. 4). A control module operates in accordance with a controller 1102 which includes, for example, one or more processors (e.g., one or more computer processors such as microprocessors or microcontrollers or both) similar to processor 304, short-term and/or long-term data storage (e.g., memory random-access memory or flash memory or both) similar to main memory 306, ROM 1308, and storage device 210, and instructions stored in memory that carry out operations of the controller 1102 when the instructions are executed (e.g., by the one or more processors).

In an embodiment, the controller 1102 receives data representing a desired output 1104. The desired output 1104 typically includes a velocity, e.g., a speed and a heading. The desired output 1104 can be based on, for example, data received from a planning module 404 (e.g., as shown in FIG. 4). In accordance with the desired output 1104, the controller 1102 produces data usable as a throttle input 1106 and a steering input 1108. The throttle input 1106 represents the magnitude in which to engage the throttle (e.g., acceleration control) of an AV 100, e.g., by engaging the steering pedal, or engaging another throttle control, to achieve the desired output 1104. In some examples, the throttle input 1106 also includes data usable to engage the brake (e.g., deceleration control) of the AV 100. The steering input 1108 represents a steering angle, e.g., the angle at which the steering control (e.g., steering wheel, steering angle actuator, or other functionality for controlling steering angle) of the AV should be positioned to achieve the desired output 1104.

In an embodiment, the controller 1102 receives feedback that is used in adjusting the inputs provided to the throttle and steering. For example, if the AV 100 encounters a disturbance 1110, such as a hill, the measured speed 1112 of the AV 100 is lowered below the desired output speed. In an embodiment, any measured output 1114 is provided to the controller 1102 so that the necessary adjustments are performed, e.g., based on the differential 1113 between the measured speed and desired output. The measured output 1114 includes measured position 1116, measured velocity 1118, (including speed and heading), measured acceleration 1120, and other outputs measurable by sensors of the AV 100.

In an embodiment, information about the disturbance 1110 is detected in advance, e.g., by a sensor such as a camera or LiDAR sensor, and provided to a predictive feedback module 1122. The predictive feedback module 1122 then provides information to the controller 1102 that the controller 1102 can use to adjust accordingly. For example, if the sensors of the AV 100 detect (“see”) a hill, this information can be used by the controller 1102 to prepare to engage the throttle at the appropriate time to avoid significant deceleration.

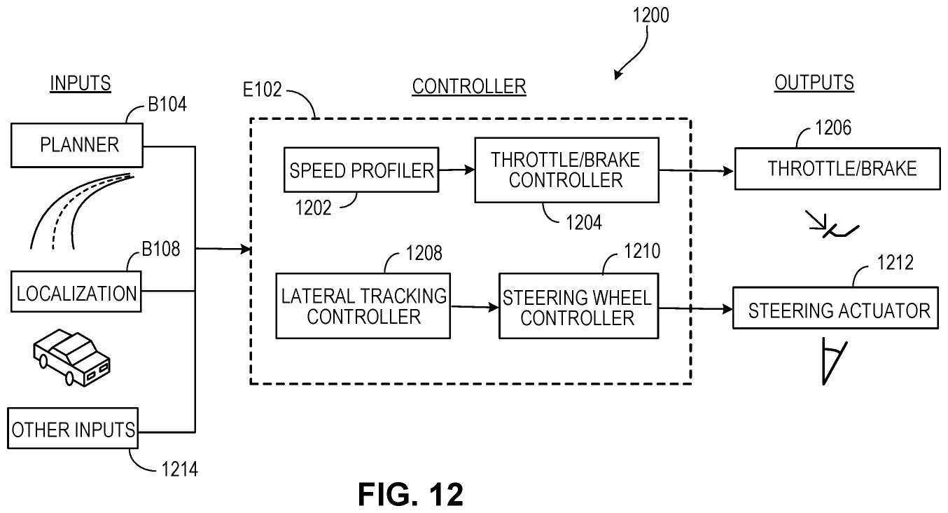

FIG. 12 shows a block diagram 1200 of the inputs, outputs, and components of the controller 1102. The controller 1102 has a speed profiler 1202 which affects the operation of a throttle/brake controller 1204. For example, the speed profiler 1202 instructs the throttle/brake controller 1204 to engage acceleration or engage deceleration using the throttle/brake 1206 depending on, e.g., feedback received by the controller 1102 and processed by the speed profiler 1202.

The controller 1102 also has a lateral tracking controller 1208 which affects the operation of a steering controller 1210. For example, the lateral tracking controller 1208 instructs the steering controller 1204 to adjust the position of the steering angle actuator 1212 depending on, e.g., feedback received by the controller 1102 and processed by the lateral tracking controller 1208.

The controller 1102 receives several inputs used to determine how to control the throttle/brake 1206 and steering angle actuator 1212. A planning module 404 provides information used by the controller 1102, for example, to choose a heading when the AV 100 begins operation and to determine which road segment to traverse when the AV 100 reaches an intersection. A localization module 408 provides information to the controller 1102 describing the current location of the AV 100, for example, so that the controller 1102 can determine if the AV 100 is at a location expected based on the manner in which the throttle/brake 1206 and steering angle actuator 1212 are being controlled. In an embodiment, the controller 1102 receives information from other inputs 1214, e.g., information received from databases, computer networks, etc.

### Transporting Passengers/Objects Using AVs

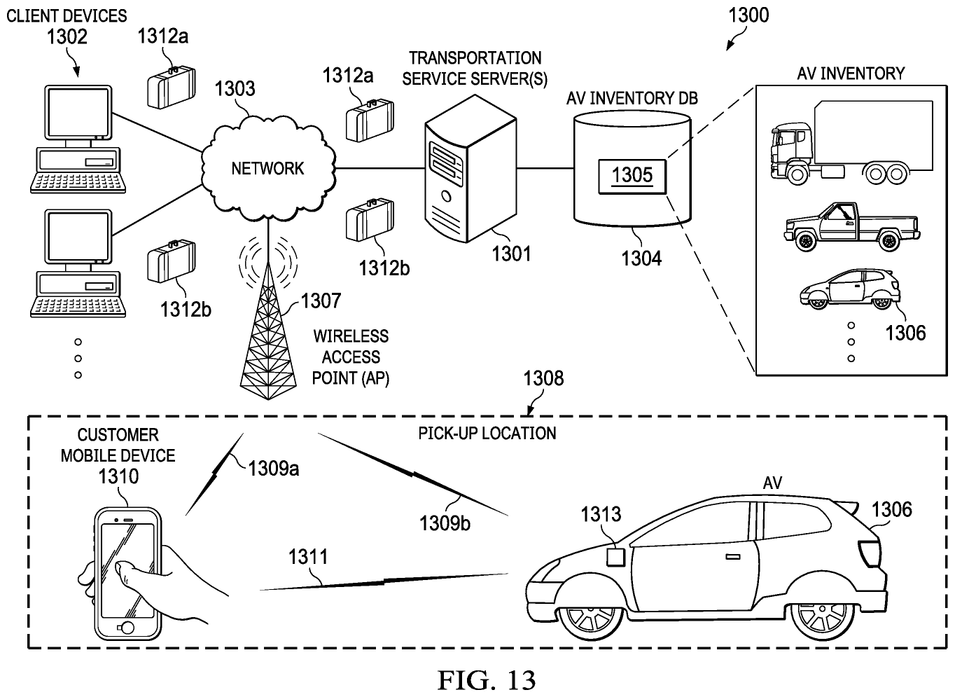

FIG. 13 shows a system 1300 for procuring AVs such as taxis, rental cars, moving vans and any other type of AV, including managing the transport of objects and/or passengers in the AVs. In an embodiment, the system 1300 includes transportation service provider computer system 1301 (e.g., one or more server computers), client devices 1302 (e.g., desktop computers, mobile devices, Kiosks), network 1303 (e.g., Internet or other wide area network), database 1304, access point 1307 (e.g., WiFi routers, cell towers), AV 1306 and customer mobile device 1310 (e.g., a smartphone, tablet computer, wearable computer).

In operation, a customer uses a client device 1302 to request transportation services (e.g., taxi service, rental, moving service) from transportation service provider computer system 1301. The customer's request includes but is not limited to: pick-up date, drop-off date (or number of days needed), pick-up time window, pick-up and drop-off locations, the number of passengers if any, the number of objects to be transported, the identities and other personal information of the passenger(s) if any and description(s) of the obj ect(s). The description of an object can include but is not limited to: the physical characteristics of the object (e.g., height, width, length, weight, color), type of object (e.g., luggage, cargo, skis, plants, animals, groceries), transport or shipping requirements (e.g., refrigerated storage, secure storage) and any other data or information that can be used to identify or describe the object. In the example shown, there are two customers using customer devices 1302a, 1302b, respectively, that have provided object descriptions 1312a, 1312b, respectively, to transportation service provider computer system 1301 over network 1303.

In an embodiment, the transportation service provider computer system 1301 searches AV inventory 1305 in database 1304 for AVs that match the requirements of the customers for storage space and other amenities (e.g., navigation system, four-wheel or all-wheel drive, baby seat, flat bed). In the example shown, autonomous taxi 1306 is found to meet the requirements specified by the customers via their respective client devices 1302a, 1302b, including appropriate storage space for their respective object(s). In this example, the transportation service provider computer system 1301 confirms the reservation for the autonomous taxi 1306 and assigns a passenger AV with appropriately sized storage space to accommodate the customers' objects.

On or before the pick-up date, transportation service provider computer system 1301 configures the computer system 1313 on the AV 1306 including downloading reservation details, such as the identities of any passengers and the descriptions 1312a, 1312b of the objects. For example, the reservation details can be downloaded through network 1303 and AP 1307 to the AV computer system 1313 using an over-the-air (OTA) update. After being configured, the AV 1306 is dispatched to the pick-up location 1308. At some time within the pick-up time window (e.g., 30 minutes), the AV 1306 arrives at the pick-up location 1308, where the AV 1306 is greeted by the passengers.

At the pick-up location 1308, each passenger can use their respective mobile device 1310 to authenticate with the AV computer system 1313 (see, e.g., computer system 300 in FIG. 3) over wireless communication link 1311. In an embodiment, the mobile device 1311 can authenticate with transportation service computer system 1301 over wireless communication link 1309a, AP 1307 (e.g., a cell tower) and network 1303 (e.g., the Internet). In an embodiment, passenger authentication data includes passenger credentials (e.g., user ID, passcode), client mobile device ID, timestamp, geographic location, biometric data (e.g., fingerprint, retina scan, faceprint, etc.) and any other or additional data that can be used authenticate the passengers (e.g., cryptographic data, such as symmetric keys, etc.). Upon successful authentication, the AV 1306 opens its passenger doors and its storage space, which in this example is a trunk. The passengers load their respective objects into the storage space of the AV 1306.

After the passengers' objects are loaded, the objects are authenticated. In an embodiment, each object has an RFID tag that was attached by the passenger. The RFID tags are read by an RFID reader in the storage space. For example, the RFID reader reads data (e.g., code or unique identifier) from the RFID tags that can be compared to object data stored in database 1304 and/or stored locally in AV 1306 (e.g., storage device 310). In an embodiment, the data read by the RFID reader uniquely identifies the object. The data is combined with a current timestamp and geographic location of the AV 1306 and then sent by a wireless transmitter of the AV to the transportation service provider computer system 1301 (through AP 1307 and network 1303) for remote authentication. In an embodiment, authentication can be performed in lieu of or in addition to remote authentication.

In an embodiment, one or more sensors inside the storage space scan and measure the physical characteristics of the passengers' objects. For example, a camera can scan and measure the physical characteristics of each object in the storage space, such as the height, width, length and weight of each object. A digital scale built-in to the bottom of the storage space can weigh the objects. The scale can be segmented so that each object can be weighed separately to avoid each object being loaded and weighed separately. The weight of the object can be used to ensure that the load capacity of the AV 1306 is not exceeded and/or to determine a fee for transporting the object based on its weight.

In an embodiment, the object data (e.g., the physical characteristics of the objects) are compared with object descriptions (e.g., physical characteristics of the objects previously provided by the customers and stored in database 1304). In accordance with object data matching the object descriptions, the AV computer system 1313 initiates a first action, such as open the passenger doors. In accordance with the object data not matching the object descriptions, the AV computer system 1313 initiates a second action that is different than the firs action, such as lock the passenger doors and/or preventing the storage space from being closed or locked. In an embodiment, the passengers receive instructions for authentication, such as calling the transportation service provide and providing the authentication data or through some other means of communication.

After the passengers and objects are authenticated, the passenger doors are unlocked and the passengers enter the AV 1306. In an embodiment, one or more sensors inside the AV passenger compartment perform an additional authentication of the passengers to confirm that only authorized passengers have entered the AV 1306. For example, cameras in the passenger compartment can detect the number of passengers in the AV 1306. Alternatively, a wireless access point in the AV 1306 can initiate passenger authentication by sending an authentication request to the passengers' personal devices, or using a one or more of a touch sensitive display, biometric scanner or speech recognition system in the passenger compartment to obtain credentials from each passenger. After each passenger occupying the passenger compartment of the AV 1306 are authenticated, the passenger doors are shut and locked and the AV 1306 is operated to drive to the scheduled drop-off location according to a route plan generated by the AV 1306 planning module or by the transportation service provider computer system 1301.

In addition to authentication, in an embodiment one or more sensors located in the storage space scan the objects to determine if the objects are unsafe or illegal for transport. For example, the sensors can include but are not limited to: an x-ray scanner, infrared radiation scanner, terahertz radiation, scanner chemical signature analyzer, catalytic gas sensor, electrochemical sensor, photo ionization sensor, weighing scale, camera, ultrasound scanner, ion mobility spectrometer, surface acoustic wave (SAW) sensor, nuclear quadrupole resonance (NQR) sensor and a low intensity gamma radiation emitter and scintillation detector. If a hazardous material or contraband is detected, the AV 1306 initiates or causes one or more actions to be performed. For example, the AV 1306 can be disabled and/or its storage space and passenger doors locked. In an embodiment, the AV 1306 can be operated to drive to a police station or other government authority/agent (e.g., customs inspection station). In an embodiment, the AV 1306 can request more information from the passengers (e.g., through an audio system in the passenger compartment or through the passengers mobile devices) re the objects to determine if the unsafe/illegal object is transportable with certain precautions undertaken or with proper authorization or waiver from an authority.

In an embodiment, if the AV 1306 makes an unscheduled stop and/or any passenger or object is removed from the storage space, the AV 1306 logs the activity with a time stamp and sensor data (e.g., camera data). For example, if an object is removed from the storage space that has an RFID tag, then the RFID reader will detect a drop in signal strength and in response send an alert message to the AV computer system 1303 and/or a personal device of the passenger associated with the object. In an embodiment, the storage space can remain locked until the drop-off location is reached. Any attempt to override the lock and remove objects is logged by the AV computer system 1313. In an embodiment, all unauthorized stops are disallowed unless the passenger requests the unauthorized stop in route and provides a reason for the stop (e.g., an emergency).

In an embodiment where the drop-off location is a transportation facility such as an airport, train station, boat dock or mass transit (e.g., a bus station, light rail), the AV 1306 can be programmed to make two drop-offs: one for the passengers and one for the passengers' objects (e.g., luggage). After dropping the passengers off at terminal or station, the AV 1306 locks its luggage space and passenger doors and navigates to a drop-off station (e.g., a baggage claim station). A transportation facility employee or agent can be provided with a code to open the storage space to remove the luggage. The employee/agent then removes the luggage and places it on a conveyor/vehicle where the luggage can be run through security (e.g., run through an x- ray machine, chemical analyzer), and then loaded on an aircraft, train, boat or other mass transit vehicle (e.g., bus, shuttle). In addition to authentication, the RFID tags attached to the luggage can be used to track the luggage and ensure it is loaded onto the proper aircraft, train, vessel, bus, etc.

The foregoing airport application described above provides an advantage in that a customer can avoid the inconvenience of checking their bags in the terminal or at the gate, or avoid standing in line to engage with a skycap or porter for curbside baggage check-in. Another advantage is that the built-in digital scale can transmit the recorded weights of the objects to an airline baggage system, allowing the customer to be automatically charged for the overweight items or any additional bags. Yet another advantage is that additional security data (e.g., x-ray scan) can be transmitted to the airport security computers by the AV, thus providing an additional line of defense to criminal or terrorist activities.

The foregoing description of system 1300 provides several advantages, such authenticating and tracking passengers and their objects transported in an AV, while also ensuring that the transported objects are safe and legal to transport. Additionally, an appropriate AV can be assigned to a customer that has sufficient storage space for their object(s), thus avoiding the delay and inconvenience of last minute upgrades to larger AVs or paying for storage space that is not used.

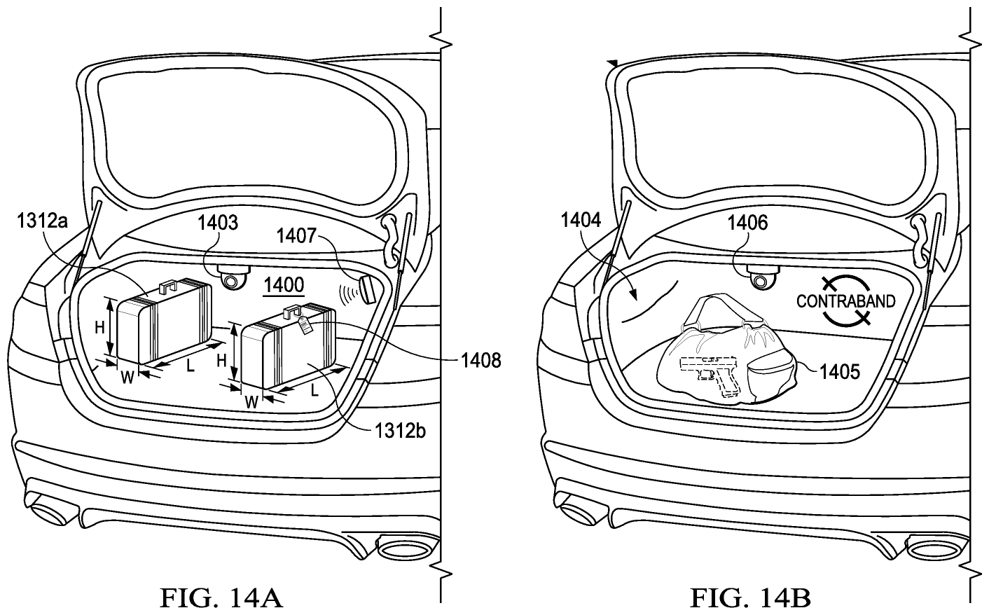

FIGS. 14A and 14B show the use of sensors to scan and measure objects in a storage space 1400 of AV 1306. At the pick-up location 1308, and after the passenger authenticates with the AV 1306, the storage space 1400 is unlocked. Referring to FIG. 14A, the AV 1306 is an automated taxi and the storage space 1400 is a trunk in the back of the AV. The trunk 1400 includes sensors 1403 and 1407. In the example shown, sensor 1403 is a camera and sensor 1407 is an RFID reader. Suitcases 1409, 1410 are shown stored in the trunk 1400, each having dimensions height (H), width (W) and length (L). A digital weighing scale in the floor of the trunk (not shown) weighs the suitcases 1409, 1410.

In an embodiment, the dimensions of the suitcases 1409, 1410 can be measured by determining a pixels-per-metric ratio (e.g., pixels-per-inch), which is the number of pixels that can fit into a given number of inches, millimeters, meters, etc. The ratio can be determined using a reference object with known dimensions (e.g., height, width, length) in the desired units (e.g., inches, millimeters) and placing the reference object in the trunk at location where it can be captured by the camera 1403 without being obscured by the suitcases 1409, 1410. The reference object should be the same distance from the lens as the suitcases. The reference object is then used to determine the pixels-per-metric ratio. In an embodiment where RFID tags are used, an RFID tag (having known dimensions) can be used as a reference object. Although one camera 1403 is shown in this example, more than one camera including stereo cameras (for estimating depth/height) can be used.

After the ratio is determined, the size of suitcases 1409, 1410 are determined by counting the pixels in the image for the suitcases 1409, 1410 and then dividing those numbers by the pixels-per-metric ratio to determine the size of the suitcases 1409, 1410. In an embodiment, the intrinsic and extrinsic parameters of the camera 1403 can be calibrated to correct for radial and tangential lens distortion. In an embodiment, one or more of machine learning, deep learning, image templates and/or image segmentation algorithms/circuits can be used for object detection and/or recognition.

Referring to FIG. 14B, in an embodiment one or more sensors are used to detect hazardous materials and contraband (e.g., explosives, illegal firearms, narcotics, flammable liquids, fruit or vegetables with invasive pests). In the example shown, sensor 1406 is an infrared or terahertz radiation scanner. A duffle bag 1405 in the trunk 1406 is scanned by the infrared/terahertz scanner 1406 to reveal contraband (e.g., an illegal firearm). When hazardous material or contraband is detected, the AV 1306 performs a specified actions based on the materials/items detected, including disabling the AV, locking the storage space and/or passenger doors, operating the AV to drive to a predefined destination (e.g., inspection station, police station), sending alerts to law enforcement or other government entity, requesting additional information from the passengers and any other suitable actions.

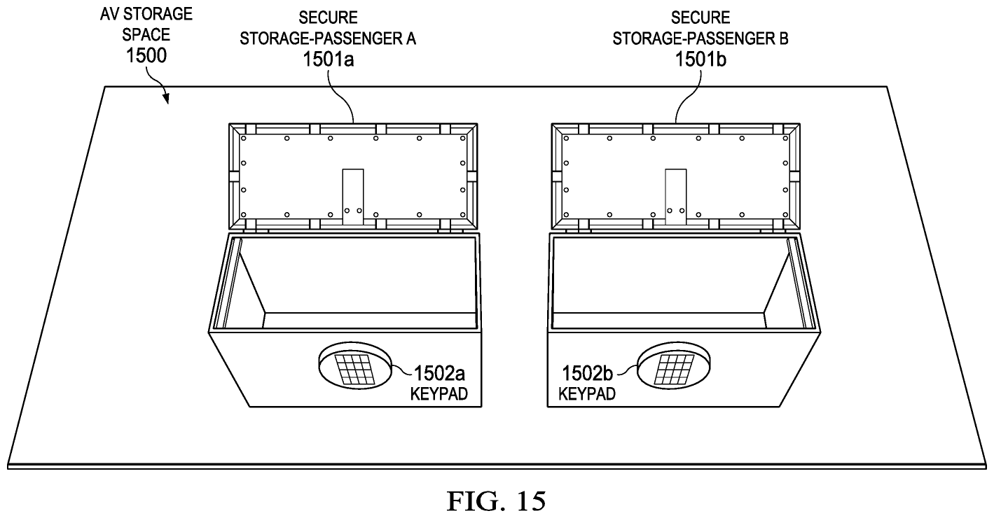

FIG. 15 shows the use of individually lockable storage containers for securely storing objects. In an embodiment, the storage space 1500 of an AV is divided into individual lockable zones, partitions, compartments or lockers (hereinafter collectively referred to as “containers”). In the example shown, storage space 1500 includes containers 1501a, 1501b. Containers 1501a, 1502 can be any size or shape. In this example, container 1501a is locked/unlocked using keypad 1502a and container 1501b is locked/unlocked using keypad 1502b. However, any locking/unlocking mechanism can be used. Each container 1501a, 1501b can be assigned to one or more passengers in the AV. The passengers can be sent pass codes on their personal devices (e.g., smartphone, tablet computer, wearable computer). In an embodiment, the containers 1501a, 1501b can include magnetic locks that are released when the correct passcode is entered into the keypad. A number of pass code “retries” can be set, such that if the number is exceeded, instructions are provided to the passenger for resetting the passcode. For example, the passenger can be required to contact the transportation service provider by phone to have the passcode reset remotely. In an embodiment, instead of a keypad, or in addition to a key pad, the passenger can unlock their container using their personal device (a remote unlocking device). In an embodiment, the transportation service provider can lock and unlock the containers 1501a, 1501b remotely, including overriding or resetting the customer's passcode.

In an embodiment, the containers 1501a, 1502 can include their own microclimates depending on the objects being stored. For example, container 1501a can be a refrigerated container for shipping perishable goods (e.g., organic materials, drugs and other chemicals requiring refrigeration). The containers 1501a, 1501b can be fireproof, shockproof and/or waterproof.

An advantage of having separate containers over a shared storage space is improved security. For example, passengers sharing an AV are prevented from unintentionally or intentionally taking another passenger's belongings. Each time the containers 1501a, 1501b are opened or closed the time of the access and the geographic location of the AV during the access is recorded in a log stored on the AV and/or sent to the transportation service provider for storage. Another advantage is that hazardous materials/contraband can be locked in the containers 1501a, 1501b, which together with the aforementioned use of sensors, has a deterrent effect on using the AV for criminal purposes (e.g., smuggling). In an embodiment, the containers 1501a, 1501b include one or more sensors for authentication and scanning for unsafe or illegal objects.

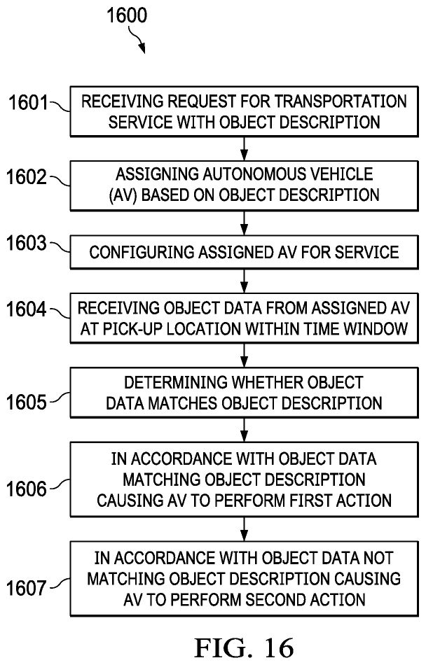

FIG. 16 shows a process 1600 performed by a transportation service computer system for managing the transportation of passengers and objects. At least one step of process 1600 can be performed by AV computer system 300 (FIG. 300).

Process 1600 can begin by receiving a request for a transportation service with one or more object descriptions (1601). For example, a customer can log into a travel booking website and use affordances of a graphical user interface (GUI) to make a reservation for an AV and to submit personal information, credentials, descriptions of objects to be transported, etc.

Process 1600 can continue by assigning an AV to the customer based at least in part on the one or more object descriptions (1602). For example, the object descriptions can include the physical characteristics of the object (e.g., height, width, length, weight, color) and other information (e.g., style, make, model). The object descriptions can be used to generate a query for searching an AV inventory in a database. The search results can include one or more AVs that match the user's specifications, and also have storage space that can accommodate the objects. In an embodiment, the term “match” means either an exact match, a partial match or a match to within a specified criteria, tolerance, threshold or level.

Process 1600 can continue by configuring the assigned AV for the requested service (1603). For example, on or before the pick-up day, the assigned AV can be configured (or programmed) with the reservation details, such as passenger details if any, and description(s) of object(s) to be transported by the assigned AV.

Process 1600 can continue by receiving object data from the assigned AV at the pick-up location and within a pick-up time window (1604). For example, at the pick-up location one or more sensors in the storage space of the AV scan and measure the obj ect(s) in the storage space or a container in the storage space. The sensor data can be processed by an AV computer system (e.g., computer system 300) or transferred to a remote computer system (e.g., one or more server computers) operated by the transportation service provider.

Process 1600 can continue by determining whether the object data matches the one or more object descriptions (1605). In accordance with the object data matching the one or more object descriptions, causing the AV to perform a first action (1606). In accordance with the object data not matching the one or more object descriptions, causing the AV to perform a second action (1607).

The step of determining a match between the object data and object descriptions can performed by the AV computer system and/or by the transportation service provider computer system. In an embodiment, the transportation service provider computer system can be a distributed computer system accessible over the Internet or other wide area network. Physical characteristics (e.g., height, width, length, weight, color) can be compared with the physical characteristics provided by the customer when the reservation was made. A tolerance threshold can be used to determine if a “match” has occurred to allow for measurement error in the object data due to, for example, camera lens distortion or other noise. In an embodiment, object detection and/or recognition can be performed and used to generate sample data with bounding boxes around each object in the image and a label for the object (e.g., suitcase, skis, duffle bag, box, suit bag).

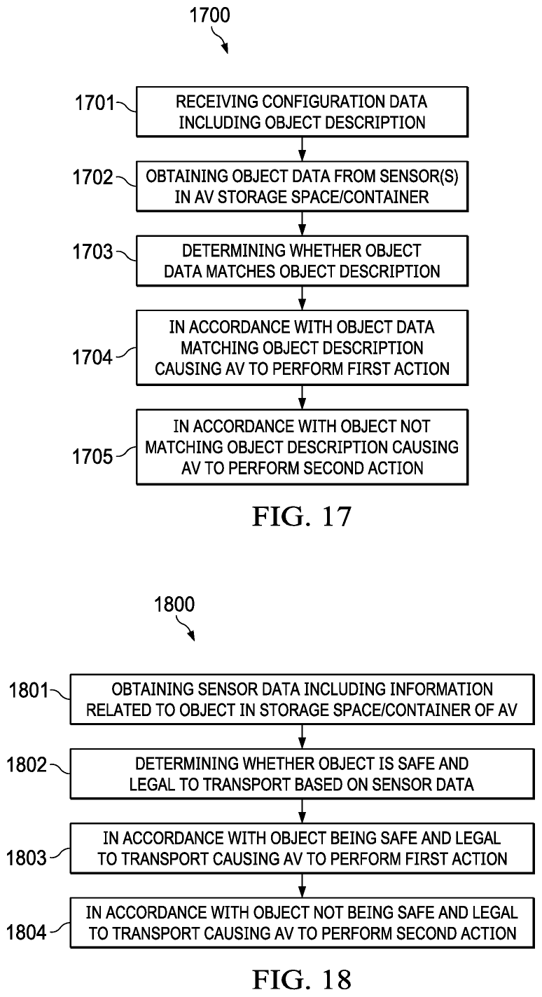

FIG. 17 shows a process performed by an autonomous vehicle computer system for managing the transportation of passengers and objects. At least one step of process 1700 can be performed by AV computer system 300 (FIG. 300).

Process 1700 begins by receiving configuration data including one or more object description(s) (1701). For example, the configuration data can include downloading reservation details to the AV computer system, including but not limited to: reservation details, passenger details if any and object details.

Process 1700 continues by obtaining object data from sensor(s) in the AV storage space/container (1702). For example, one or more sensors located in the storage space and/or containers of the AV scan and measure the objects. In an embodiment, an RFID tag is attached to an object and an RFID reader in the storage space/container reads a unique identifier/code from the tag, which can be used to authenticate the object, as previously described in reference to FIGS. 14A and 14B.

Process 1700 continues by determining whether object data matches the one or more object description(s) (1703). In accordance with the object data matching the one or more object description(s), causing the AV to perform a first action (1704). In accordance with the object data not matching the one or more object description(s), causing the AV to perform a second action (1705).

The step of determining a match between the object data and object descriptions can performed by the AV computer system and/or by the transportation service provider computer system.

FIG. 18 shows a process for detecting and reporting unsafe and/or contraband objects transported by autonomous vehicles. At least one step of process 1800 can be performed by AV computer system 300 (FIG. 300).

Process 1800 can begin by obtaining object data including information related to one or more objects in a storage space/container of the AV (1801). For example, an infrared or terahertz radiation sensor can be used to scan objects in the storage space of the AV. The scan data can be used to generate object data by performing further processing

Process 1800 can continue by determining whether the one or more objects are safe and legal to transport based on the object data (1802). In accordance with the one or more objects being safe and legal to transport, the AV performs a first action (1803). In accordance with the one or more objects not being safe and legal to transport, the AV perform a second action (1804). For example, unique spectral “fingerprints” for various contraband (e.g., firearms) can be detected in the terahertz range.

In addition to the foregoing disclosed embodiments, the following additional embodiments can be realized as methods, systems, apparatuses and computer-readable storage mediums.

A method comprises: receiving, using a computer system of a transportation service provider, a request for an autonomous vehicle (AV), the request including a pick-up location, a drop-off location, a pick-up date, a pick-up time window and a description of an object to be transported by the AV from the pick-up location to the drop-off location; identifying, using the computer system and based on the object description, an AV having a storage space to transport the object to the drop-off location; receiving, using the computer system, object data from the AV at the pick-up location on the pick-up date and within the pick-up time window; determining, using the computer system, whether the object data matches the object description; in accordance with the object data matching the object description, causing the AV to perform a first action; and in accordance with the object data not matching the object description, causing the AV to perform a second action.

Any of the preceding methods, wherein identifying the AV to transport the object to the drop-off location, further comprises: determining, based on the object description, the physical characteristics of the object; and identifying, based on the physical characteristics, an AV having the storage space to transport the object to the drop-off location.

Any of the preceding methods, further comprising: receiving, using the computer system, one or more images of the object; determining, based on the one or more images, the physical characteristics of the object; and identifying, based on the physical characteristics of the object, an AV having the storage space to transport the object to the drop-off location.

Any of the preceding methods, wherein the one or more images includes a unique identifier that associates the object with the object description in a database accessible by the computer system.

Any of the preceding methods, further comprising: determining, using the computer system, whether the object is unsafe or illegal to transport based on the object data; in accordance with the object being safe and legal to transport, causing the AV to perform the first action; and in accordance with the object not being safe or legal to transport, causing the AV to perform the second action.

Any of the preceding methods, wherein the second action is locking the storage space and passenger doors of the AV and navigating the AV to a destination.

Any of the preceding methods, further comprising: receiving, using the computer system, authentication data from a mobile device operated by a passenger at the pick-up location; authenticating, using the computer system, the passenger based on the authentication data; associating the authenticated passenger with the object and the AV; receiving, using the computer system, first location data from the AV, the first location data including a first timestamp and a geographic location of the AV; receiving, using the computer system, second location data from the mobile device of the passenger, the second location data including a second timestamp and the geographic location of the mobile device; determining, using the computer system, that the passenger and AV are both at the pick-up location within the pick-up time window based on the first location data and the second location data; and causing, the AV to unlock a passenger door and the storage space to allow loading of the passenger and the object into the AV.

Any of the preceding methods, wherein the authentication data includes timestamped biometric data captured by the mobile device.

Any of the preceding methods, wherein causing the AV to unlock the storage space, further comprises: sending, using the computer system, a security code to the mobile device, the security code for unlocking the storage space using the mobile device.

Any of the preceding methods, wherein the storage space is one or more individually lockable storage containers.

Any of the preceding methods, wherein the object data includes an additional object not included in the object description and the computer system automatically charges a customer account a fee for the additional object.

Any of the preceding methods, wherein the object data includes a weight of the object and the computer system automatically charges a customer account a fee based on the weight of the object.

Any of the preceding methods, further comprising: determining, using the computer system, that passengers in the AV have disembarked from the AV at a transportation facility; and causing, using the computer system, the AV to navigate to a designated area in the transportation facility to drop-off the object.

A system comprising: a communications interface; one or more server computers; memory storing instructions that when executed by one or more server computers, cause the one or more server computers to perform the methods recited in any one of the preceding methods.

A non-transitory, computer-readable storage medium having instructions stored thereon, that when executed by one or more processors, cause the one or more processors to perform the method of any one of the preceding methods.

A method comprising: receiving, using a computer system of an autonomous vehicle (AV), sensor data provided by one or more sensors of the AV; generating, using the computer system and based on the sensor data, object data indicative of one or more physical characteristics of an object in a storage space or container of the AV; determining, using the computer system, whether the object data matches an object description; and in accordance with the object data matching the object description, causing, using the computer system, the AV to perform a first action; and in accordance with the object data not matching the object description, causing, using the computer system, the AV to perform a second action.

Any of the preceding methods, wherein one of the sensors is a radio frequency identification (RFID) reader, the object data includes a code identifying the object, and the RFID reader obtains the code by scanning an RFID tag attached to the object.

Any of the preceding methods, wherein determining whether the object data matches the object description, further comprises: sending, using a wireless transmitter of the AV, the object data to a network-based server computer; and receiving, using a wireless receiver of the AV, data from the network-based server computer indicating whether the object data matches the object description.

Any of the preceding methods, further comprising: determining, using the computer system, a first timestamp and a first geographic location of the AV; determining, using the computer system, whether the first geographic location of the AV is a predetermined pick-up location for the object; determining, using the computer system, whether the first timestamp is within a predefined pick-up time window for the object; and in accordance with the first geographic location of the AV being the predetermined pick-up location and the first timestamp being within the predefined pick-up time window for the object; causing, using the computer system, the AV to perform a first action; in accordance with the first geographic location of the AV not being the predetermined pick-up location or the first timestamp not being within the predefined pick-up time window for the object; and causing, using the computer system, the AV to perform a second action.

Any of the preceding methods, further comprising: determining, using the computer system, a second timestamp and a second geographic location of a mobile device; determining, using the computer system, whether the second geographic location of the mobile device is the predetermined pick-up location for a passenger of the AV; determining, using the computer system, whether the second timestamp is within a predefined pick-up time window for the passenger of the AV; and in accordance with the second geographic location of the AV being the predetermined pick-up location for the passenger of the AV and the second timestamp being within the predefined pick-up time window for the passenger of the AV; causing, using the computer system, the AV to perform the first action; in accordance with the second geographic location of the passenger of the AV not being the predetermined pick-up location for the passenger of the AV or the second timestamp not being within the predefined pick-up time window for the passenger of the AV; causing, using the computer system, the AV to perform the second action.

Any of the preceding methods, wherein the first action includes unlocking the storage space or unlocking the container, and the second action includes locking the storage space or locking the container.

Any of the preceding methods, further comprising: determining, using the object data, whether the object is hazardous for transport; and in accordance with the object being hazardous for transport; causing, using the computer system, the AV to perform the first action; in accordance with the object not being hazardous for transport; causing, using the computer system, the AV to perform the second action.

Any of the preceding methods, further comprising: determining, using the object data, whether the object is illegal to transport; and in accordance with the object being illegal to transport; causing, using the computer system, the AV to perform the first action; in accordance with the object not being legal to transport; causing, using the computer system, the AV to perform the second action.

Any of the preceding methods, wherein the first action includes generating an alert indicating that the object is hazardous or illegal to transport and sending the alert to one or more entities.

Any of the preceding methods, wherein the first action includes locking the storage space or container and passenger doors of the AV and operating the AV to drive to a predefined destination.

Any of the preceding methods, further comprising: determining, using the computer system, that the AV is located at a predefined drop-off location; and unlocking, using the computer system, the storage space or container and one or more passenger doors of the AV.

Any of the preceding methods, further comprising: determining, using the computer system, that the AV has stopped at an unscheduled drop-off location; and determining, using the computer system, whether the object has been removed from the storage space or container; in accordance with the object being removed from the storage space or container; causing, using the computer system, the AV to perform the first action; in accordance with the object not being removed from the storage space or container; causing, using the computer system, the AV to perform the second action.

Any of the preceding methods, wherein the first action includes generating an alert indicating that the object has been removed and sending the alert to one or more entities.

Any of the preceding methods, wherein the alert is sent to a mobile device of passenger of the AV associated with the object.

An autonomous vehicle (AV), comprising: a communications interface; a computer system; memory storing instructions that when executed by one or more processing circuits of the computer system, cause the computer system to perform the methods recited in any one of the preceding method claims.

A non-transitory, computer-readable storage medium having instructions stored thereon, that when executed by one or more processing circuits of a computer system, cause the computer system to perform the method of any one of the preceding method claims.

A method comprising: determining, using a computer system of an autonomous vehicle (AV), that the AV is located at a transportation facility; determining, using the computer system, that a passenger in the AV has disembarked from the AV; operating, using the computer system, the AV to drive to a drop-off location for an object transported by the AV, the object belonging to the passenger that disembarked from the AV; determining, using the computer system, that the AV is located at the drop-off location; determining, using the computer system, whether the object was removed from a storage space or container of the AV; and in accordance with the object being removed from the storage space or container; causing, using the computer system, the AV to perform the first action; in accordance with the object not being removed from the storage space or container; causing, using the computer system, the AV to perform the second action.

Any of the preceding methods, wherein the first action includes generating an alert that the object has been dropped-off at the drop-off location, and sending the alert to a mobile device associated with the passenger.

Any of the preceding methods, the method of claim 30, further comprising: scanning, using one or more sensors of the AV, the object; generating, using the computer system, object data; and sending, using a wireless transmitter of the AV, the object data to a transportation facility computer system.

Any of the preceding methods, the method of claim 32, wherein the object data includes at least one of x-ray scan data or chemical analysis data, and the computer system sends the at least one of x-ray data scan data or chemical analysis data to a transportation security administration computer system.

Any of the preceding methods, wherein the object data indicates that the object contains a prohibited item or material, and the AV is operated, using the computer system, to drive to an inspection station for the transportation security administration.

Any of the preceding methods, wherein the transportation facility is an airport.

An autonomous vehicle (AV), comprising: a communications interface; a computer system; memory storing instructions that when executed by one or more processing circuits of the computer system, cause the computer system to perform the methods recited in any one of the preceding method claims.

A non-transitory, computer-readable storage medium having instructions stored thereon, that when executed by one or more processing circuits of a computer system, cause the computer system to perform the method of any one of the preceding method claims.

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A method comprising:
receiving, using a computer system of a transportation service provider, a request for an autonomous vehicle (AV), the request including a pick-up location, a drop-off location, a pick-up date, a pick-up time window and a description of an object to be transported by the AV from the pick-up location to the drop-off location;
identifying, using the computer system and based on the object description, an AV having a storage space to transport the object to the drop-off location;
receiving, using the computer system, object data from the AV at the pick-up location on the pick-up date and within the pick-up time window;
determining, using the computer system, whether the object data matches the object description;
in accordance with the object data matching the object description, causing the AV to perform a first action; and
in accordance with the object data not matching the object description, causing the AV to perform a second action.

2. The method of claim 1, wherein identifying the AV to transport the object to the drop-off location, further comprises:
determining, based on the object description, the physical characteristics of the object; and
identifying, based on the physical characteristics, an AV having the storage space to transport the object to the drop-off location.

3. The method of claim 1, further comprising:
receiving, using the computer system, one or more images of the object;
determining, based on the one or more images, the physical characteristics of the object; and
identifying, based on the physical characteristics of the object, an AV having the storage space to transport the object to the drop-off location.

4. The method of claim 3, wherein the one or more images includes a unique identifier that associates the object with the object description in a database accessible by the computer system.

5. The method of claim 1, further comprising:
determining, using the computer system, whether the object is unsafe or illegal to transport based on the object data;
in accordance with the object being safe and legal to transport, causing the AV to perform the first action; and
in accordance with the object not being safe or legal to transport, causing the AV to perform the second action.

6. The method of claim 5, wherein the second action is locking the storage space and passenger doors of the AV and navigating the AV to a destination.

7. The method of claim 1, further comprising:
receiving, using the computer system, authentication data from a mobile device operated by a passenger at the pick-up location;
authenticating, using the computer system, the passenger based on the authentication data;
associating the authenticated passenger with the object and the AV;
receiving, using the computer system, first location data from the AV, the first location data including a first timestamp and a geographic location of the AV;
receiving, using the computer system, second location data from the mobile device of the passenger, the second location data including a second timestamp and the geographic location of the mobile device;
determining, using the computer system, that the passenger and AV are both at the pick- up location within the pick-up time window based on the first location data and the second location data; and
causing, the AV to unlock a passenger door and the storage space to allow loading of the passenger and the object into the AV.

8. The method of claim 7, wherein the authentication data includes timestamped biometric data captured by the mobile device.

9. The method of claim 7, wherein causing the AV to unlock the storage space, further comprises:
sending, using the computer system, a security code to the mobile device, the security code for unlocking the storage space using the mobile device.

10. The method of claim 1, wherein the storage space is one or more individually lockable storage containers.

11. The method of claim 1, wherein the object data includes an additional object not included in the object description and the computer system automatically charges a customer account a fee for the additional object.

12. The method of claim 1, wherein the object data includes a weight of the object and the computer system automatically charges a customer account a fee based on the weight of the obj ect.

13. The method of claim 1, further comprising:
determining, using the computer system, that passengers in the AV have disembarked from the AV at a transportation facility; and
causing, using the computer system, the AV to navigate to a designated area in the transportation facility to drop-off the object.

14. A system comprising:
a communications interface;
one or more computers;
memory storing instructions that when executed by one or more computers, cause the one or more computers to perform operations comprising:
receiving a request for an autonomous vehicle (AV), the request including a pick-up location, a drop-off location, a pick-up date, a pick-up time window and a description of an object to be transported by the AV from the pick-up location to the drop-off location;
identifying, based on the object description, an AV having a storage space to transport the object to the drop-off location;
receiving object data from the AV at the pick-up location on the pick-up date and within the pick-up time window;
determining whether the object data matches the object description;
in accordance with the object data matching the object description, causing the AV to perform a first action; and
in accordance with the object data not matching the object description, causing the AV to perform a second action.

15. A non-transitory, computer-readable storage medium having instructions stored thereon, that when executed by one or more processors, cause the one or more processors to perform operations comprising:
receiving a request for an autonomous vehicle (AV), the request including a pick-up location, a drop-off location, a pick-up date, a pick-up time window and a description of an object to be transported by the AV from the pick-up location to the drop-off location;
identifying, based on the object description, an AV having a storage space to transport the object to the drop-off location;
receiving object data from the AV at the pick-up location on the pick-up date and within the pick-up time window;
determining whether the object data matches the object description;
in accordance with the object data matching the object description, causing the AV to perform a first action; and
in accordance with the object data not matching the object description, causing the AV to perform a second action.

16. A method comprising:
receiving, using a computer system of an autonomous vehicle (AV), sensor data provided by one or more sensors of the AV;
generating, using the computer system and based on the sensor data, object data indicative of one or more physical characteristics of an object in a storage space or container of the AV;
determining, using the computer system, whether the object data matches an object description; and
in accordance with the object data matching the object description,
causing, using the computer system, the AV to perform a first action; and
in accordance with the object data not matching the object description,
causing, using the computer system, the AV to perform a second action.

17. The method of claim 16, wherein one of the sensors is a radio frequency identification (RFID) reader, the object data includes a code identifying the object, and the RFID reader obtains the code by scanning an RFID tag attached to the object.

18. The method of claim 16, wherein determining whether the object data matches the object description, further comprises:
sending, using a wireless transmitter of the AV, the object data to a network-based server computer; and
receiving, using a wireless receiver of the AV, data from the network-based server computer indicating whether the object data matches the object description.

19. The method of claim 16, further comprising:
determining, using the computer system, a first timestamp and a first geographic location of the AV;
determining, using the computer system, whether the first geographic location of the AV is a predetermined pick-up location for the object;
determining, using the computer system, whether the first timestamp is within a predefined pick-up time window for the object; and
in accordance with the first geographic location of the AV being the predetermined pick- up location and the first timestamp being within the predefined pick-up time window for the object;
causing, using the computer system, the AV to perform a first action;
in accordance with the first geographic location of the AV not being the predetermined pick-up location or the first timestamp not being within the predefined pick-up time window for the object; and
causing, using the computer system, the AV to perform a second action.

20. The method of claim 19, wherein the first action includes unlocking the storage space or unlocking the container, and the second action includes locking the storage space or locking the container.

21. The method of claim 19, further comprising:
determining, using the computer system, a second timestamp and a second geographic location of a mobile device;
determining, using the computer system, whether the second geographic location of the mobile device is the predetermined pick-up location for a passenger of the AV;
determining, using the computer system, whether the second timestamp is within a predefined pick-up time window for the passenger of the AV; and
in accordance with the second geographic location of the AV being the predetermined pick-up location for the passenger of the AV and the second timestamp being within the predefined pick-up time window for the passenger of the AV;
causing, using the computer system, the AV to perform the first action;
in accordance with the second geographic location of the passenger of the AV not being the predetermined pick-up location for the passenger of the AV or the second timestamp not being within the predefined pick-up time window for the passenger of the AV;
causing, using the computer system, the AV to perform the second action.

22. The method of claim 21, wherein the first action includes unlocking the storage space or unlocking the container, and the second action includes locking the storage space or locking the container.

23. The method of claim 16, further comprising:
determining, using the object data, whether the object is hazardous for transport; and
in accordance with the object being hazardous for transport;
causing, using the computer system, the AV to perform the first action;
in accordance with the object not being hazardous for transport;
causing, using the computer system, the AV to perform the second action.

24. The method of claim 23, wherein the first action includes generating an alert indicating that the object is hazardous or illegal to transport and sending the alert to one or more entities.

25. The method of claim 16, further comprising:
determining, using the object data, whether the object is illegal to transport; and
in accordance with the object being illegal to transport;
causing, using the computer system, the AV to perform the first action;
in accordance with the object not being legal to transport;
causing, using the computer system, the AV to perform the second action.

26. The method of claim 25, wherein the first action includes generating an alert indicating that the object is hazardous or illegal to transport and sending the alert to one or more entities.

27. The method of claim 25, wherein the first action includes locking the storage space or container and passenger doors of the AV and operating the AV to drive to a predefined destination.

28. The method of claim 16, further comprising:
determining, using the computer system, that the AV is located at a predefined drop-off location; and
unlocking, using the computer system, the storage space or container and one or more passenger doors of the AV.

29. The method of claim 16, further comprising:
determining, using the computer system, that the AV has stopped at an unscheduled drop- off location; and
determining, using the computer system, whether the object has been removed from the storage space or container;
in accordance with the object being removed from the storage space or container;
causing, using the computer system, the AV to perform the first action;
in accordance with the object not being removed from the storage space or container;
causing, using the computer system, the AV to perform the second action.

30. The method of claim 29, wherein the first action includes generating an alert indicating that the object has been removed and sending the alert to one or more entities.

31. The method of claim 30, wherein the alert is sent to a mobile device of passenger of the AV associated with the object.
